(19) United States
(12) Patent Application Publication
(10) Pub. No.: US 2010/0118671 A1
(43) Pub. Date: May 13, 2010

(54) TILT CONTROL METHOD, INTEGRATED CIRCUIT AND OPTICAL DISC DEVICE

(76) Inventor: Masaya Kuwahara, Hyogo (JP)

Correspondence Address: WENDEROTH, LIND & PONACK L.L.P., 1030 15th Street, N.W., Suite 400 East, Washington, DC, 20005-1503, US

(21) Appl. No.: 12/594,984

(22) PCT Filed: Apr. 9, 2008
(86) PCT No.: PCT/JP2008/000916

§ 371 Date: Oct. 7, 2009

(30) Foreign Application Priority Data
Apr. 13, 2007 (JP) 2007-105543

(51) Int. Cl. G11B 7/00

(52) U.S. Cl. 369/44.32; G9B/7

(57) ABSTRACT

There is provided an optical disc drive including a light axis deviation detection means (13) which detects a light axis deviation amount of an emission light, a tilt correction control means (15) which determines and outputs a tilt correction amount on the basis of an output of the light axis deviation detection means (13), a microcomputer (10B) which corrects an output of the tilt correction control means (15) and a warpage of a disc, and an addition means (16) which adds an output of the microcomputer (10B) and the output of the tilt correction control means (15), wherein a tilt actuator (2-9) is driven by an output of the addition means (16) through a tilt drive means (11) to control a tilt of an objective lens which focuses a light beam on the disc.

### TECHNICAL FIELD

The present invention relates to an optical disc device which reproduces or records data from or in high-density recording media such as DVDs (Digital Versatile Discs) and Blu-ray discs. More particularly, the invention relates to a tilt control method, an integrated circuit, and an optical disc device which are able to suppress influences of a coma aberration and a tilt of an objective lens mounted on a pickup, which might occur due to a lens shift.

### BACKGROUND ART

It has been known that, in a pickup of a conventional optical disc device, an objective lens is tilted at the same time as it is shifted in the disc radial direction. Further, it has also been known that a coma aberration occurs at the same time as the objective lens is shifted in the disc radial direction depending on the optical element configuration of the pickup.

Therefore, there have been proposed a pickup which prevents occurrence of a tilt even when an objective lens is shifted and a pickup which self-cancels a tilt which is caused by a lens shift by appropriately devising the configuration of a magnetic circuit in the former pickup (for example, refer to Patent Document 1 and Patent Document 2).

Patent Document 1: Japanese Published Patent Application No. Hei. 10-031829

Patent Document 2: Japanese Published Patent Application No. 2004-127422 A

### DISCLOSURE OF THE INVENTION

### Problems to be Solved by the Invention

As for a DVD or a Blu-ray disc, in order to realize high-density recording, an allowable tilt range (tilt margin) of the objective lens in the pickup is narrow, and therefore, a highly-precise tilt control is required. So, there is a demand for an optical disc device which can precisely perform reproduction of data recorded on the disc and recording of data in the disc even when a disc warpage or the like occurs.

The conventional invention disclosed in Patent Document 1 or Patent Document 2 is one which prevents occurrence of a tilt even when the objective lens is shifted or one which self-cancels a lens shift of the objective lens by appropriately devising the configuration of the magnetic circuit of the pickup. However, when an assembly precision of the pickup is required or when the assembly precision of the pickup is varied for any reason because the pickup is an accurate instrument, if a lens shift occurs, a tilt might occur or this lens shift cannot be canceled, resulting in incapability of reproduction and recording.

The present invention is made to solve the above-described problems and has for its object to provide a tilt control method, an integrated circuit, and an optical disc device which can perform tilt correction against not only a disc warpage but also a tilt of an objective lens or a coma aberration of a pickup which might occur due to a lens shift.

### Measures to Solve the Problems

(1) A first tilt control method of the present invention comprises: a first step of detecting a light axis deviation amount of an emission light from an objective lens which focuses a light beam on an optical disc; a second step of detecting a disc warpage amount of the optical disc; and a third step of controlling a tilt of the objective lens on the basis of the light axis deviation amount detected in the first step and the disc warpage amount detected in the second step.

Further, a first integrated circuit of the present invention comprises: a light axis deviation detection means which detects a light axis deviation amount of an emission light from an objective lens which focuses a light beam on an optical disc; a tilt detection means which detects a warpage of an optical disc; an objective lens tilt control means which controls a tilt of the objective lens on the basis of the output of the light axis deviation detection means and the output of the tilt detection means; and a tilt drive means which drives the objective lens on the basis of the output of the objective lens tilt control means.

(2) A second tilt control method of the present invention comprises: a first step of detecting a light axis deviation amount of an emission light from an objective lens which focuses a light beam on an optical disc; a second step of determining a tilt correction amount on the basis of the light axis deviation amount detected in the first step; a third step of adding the tilt correction amount determined in the second step and an output which corrects a warpage of the optical disc; and a fourth step of controlling a tilt of the objective lens according to the result of the addition in the third step.

Further, the second step includes determining a tilt correction amount on the basis of the light axis deviation amount detected in the first step, with the tilt of the objective lens being previously controlled with respect to the warpage of the optical disc.

Further, the second step includes performing an operation of generating a light axis deviation of a predetermined amount and detecting an output which controls the tilt of the objective lens to optimize a reproduction signal, with varying the predetermined amount on at least two points on the optical disc, calculating a ratio between the predetermined amount and the output which controls the tilt of the objective lens, and multiplying the optical axis deviation amount detected in the first step by the ratio, thereby to determine a tilt correction amount.

Further, the second step includes performing an operation of generating a light axis deviation of a predetermined amount and detecting an output which controls the tilt of the objective lens to optimize a reproduction signal, with varying the predetermined amount on at least two points on the optical disc, calculating ratios between the predetermined amounts and the output which controls the tilt of the objective lens and making a table including the ratios and the corresponding light axis deviation amounts, determining the ratio from the table according to the light axis deviation amount detected in the first step, and multiplying the optical axis deviation amount detected in the first step by the ratio, thereby to determine a tilt correction amount.

Further, the second step includes detecting an output which controls the tilt of the objective lens to optimize the reproduction signal in a state where no light axis deviation is generated, and an output which controls the tilt of the objective lens to optimize the reproduction signal in a state where a light axis deviation is generated, calculating a ratio of the output which controls the tilt of the objective lens to the optical axis deviation amount, and making the tilt correction amount zero when the ratio is smaller than a first predetermined value.

Further, the second step includes making the tilt correction amount zero when a difference between the quality of the reproduction signal in a state where no light axis deviation is generated and the quality of the reproduction signal in a state where a light axis deviation is generated is smaller than a first predetermined value.

Further, the second step includes making the tilt correction amount zero when a tracking control loop which controls positioning of the light beam onto an arbitrary track on the optical disc is open.

Further, a second integrated circuit of the present invention comprises: a light axis deviation detection means which detects a light axis deviation amount of an emission light from an objective lens which focuses a light beam on an optical disc; a tilt detection means which detects a warpage of an optical disc; a tilt control means which outputs a signal for controlling a tilt of the objective lens on the basis of the output of the tilt detection means; a tilt correction control means which determines and outputs a tilt correction amount for controlling the tilt of the objective lens on the basis of the output of the light axis deviation detection means; an addition means which adds the output of the tilt control means and the output of the tilt correction control means; and a tilt drive means which controls the tilt of the objective lens according to the output of the addition means.

Further, the tilt correction control means determines and outputs a tilt correction amount which controls the tilt of the objective lens, on the basis of the output of the light axis deviation detection means, under the state where the tilt of the objective lens with respect to the warpage of the optical disc has previously been controlled.

Further, the tilt correction control means performs an operation of generating a light axis deviation of a predetermined amount and detecting an output which controls the tilt of the objective lens to optimize a reproduction signal, with varying the predetermined amount on at least two points on the optical disc, calculates a ratio between the predetermined amount and the output which controls the tilt of the objective lens, and outputs, as a tilt correction amount, a value obtained by multiplying the output of the light axis deviation detection means by the ratio.

Further, the tilt correction control means performs an operation of generating a light axis deviation of a predetermined amount and detecting an output which controls the tilt of the objective lens to optimize a reproduction signal, with varying the predetermined amount on at least two points on the optical disc, calculates ratios between the predetermined amounts and the output which controls the tilt of the objective lens and makes a table including the ratios and the corresponding light axis deviation amounts, determines the ratio from the table according to the light axis deviation amount detected by the light axis deviation detection means, and outputs, as a tilt correction amount, a value obtained by multiplying the output of the light axis deviation detection means by the ratio.

Further, the tilt correction control means detects an output which controls the tilt of the objective lens to optimize the reproduction signal in a state where no light axis deviation is generated, and an output which controls the tilt of the objective lens to optimize the reproduction signal in a state where a light axis deviation is generated, calculates a ratio of the output which controls the tilt of the objective lens to the light axis deviation amount, and makes the tilt correction amount zero when the ratio is smaller than a first predetermined value.

Further, the tilt correction control means makes the tilt correction amount zero when a tracking control loop which controls positioning of the light beam onto an arbitrary track on the optical disc is open.

(3) An optical disc device of the present invention comprises: an objective lens which focuses a light beam on an optical disc; a tilt actuator which varies a tilt of the objective lens; a light axis deviation sensor which detects a light axis deviation of an emission light from the objective lens; a tilt detection means which detects a warpage of the optical disc; a tilt correction control means which determines and outputs a tilt correction amount on the basis of the output of the light axis deviation sensor; a tilt control means which outputs a signal for controlling the tilt of the objective lens on the basis of the output of the tilt detection means; an addition means for adding the output of the tilt control means and the output of the tilt correction control means; and a tilt drive means which drives the tilt actuator according to the output of the addition means.

### Effects of the Invention

According to the present invention, deterioration of a reproduction signal based on a reflected light from an optical disc, which deterioration is caused by a warpage of the optical disc or a tilt of an objective lens and a coma aberration of a pickup that occur due to a light axis deviation caused by a lens shift of the objective lens when recording data on the optical disc or reproducing data from the optical disc, can be accurately suppressed by performing a tilt control considering the influence by the disc warpage and the influence by the light axis deviation to appropriately correct the tilt of the objective lens.

Further, according to the present invention, deterioration of a reproduction signal based on a reflected light from an optical disc, which deterioration is caused by a warpage of the optical disc or a tilt of an objective lens and a coma aberration of a pickup that occur due to a light axis deviation caused by a lens shift of the objective lens when recording data on the optical disc or reproducing data from the optical disc, can be accurately suppressed by performing a tilt correction control which appropriately controls the influence by the light axis deviation with a correction value according to the light axis deviation amount, in addition to a disc tilt control which controls the influence of the disc warpage, to appropriately and accurately correct the tilt of the objective lens, whereby precise data recording or reproduction can be performed.

Further, since the tilt correction control is executed in addition to the tilt correction only when the objective lens is tilted exceeding a predetermined degree or when a coma aberration of the pickup occurs exceeding a predetermined degree, deterioration of a reproduction signal based on a reflected light from the recording medium can be accurately suppressed by appropriately and accurately correcting the tilt of the objective lens, and thereby precise data recording or reproduction can be performed. Furthermore, since the tilt correction control is not performed if the deterioration of the reproduction signal due to the light axis deviation is not considerable, even when the output of the light axis deviation detection means becomes abnormal due to the light axis deviation of the objective lens, an excessive input signal is not given to the tilt actuator, thereby avoiding such as malfunction of the device.

Further, according to the present invention, deterioration of a reproduction signal based on a reflected light from an optical disc, which deterioration is caused by a warpage of the optical disc or a tilt of an objective lens and a coma aberration of a pickup that occur due to a light axis deviation caused by a lens shift of the objective lens when recording data on the optical disc or reproducing data from the optical disc, can be accurately suppressed by performing a tilt correction control which accurately detects the light axis deviation and appropriately controls the influence by the light axis deviation with a correction value according to the light axis deviation amount, in addition to a tilt control which controls the influence of the disc warpage, to appropriately and accurately correct the tilt of the objective lens, whereby precise data recording or reproduction can be performed.

### BRIEF DESCRIPTION OF THE DRAWINGS

FIG. 1 is a block diagram illustrating an optical disc device 1010 according to a first embodiment of the present invention.

FIG. 2 is a diagram illustrating an reproduction signal RF amplitude (a) and lens shift characteristics of a jitter detection means output JIT (b) in the optical disc device 1010 of the first embodiment.

FIG. 3 is a diagram illustrating a light axis deviation detection means 13, a tilt detection means 14, and a microcomputer 10A in the optical disc device 1010 of the first embodiment.

FIG. 4 is a block diagram illustrating an optical disc device 1020 according to the first embodiment.

FIG. 5 is a diagram illustrating a light axis deviation detection means 13, a tilt detection means 14′, and a microcomputer 10A in the optical disc device 1020 of the first embodiment.

FIG. 6 is a block diagram illustrating an optical disc device 1030 including an integrated circuit 20 according to the first embodiment of the present invention.

FIG. 7(a) is a block diagram illustrating an optical disc device 2010 according to a second embodiment of the present invention.

FIG. 7(b) is a block diagram illustrating a tilt detection means 14 and a microcomputer 10B in the optical disc device 2010 of the second embodiment.

FIG. 8 is a diagram illustrating the configurations of a light axis deviation detection means 13 and a tilt correction control means 15 in the optical disc device 2010 of the second embodiment.

FIG. 9 is a flowchart illustrating a first determination method for determining a gain k of the tilt correction control means 15 in the optical disc device 2010 of the second embodiment.

FIG. 10 is a schematic diagram illustrating the relative positions of an optical pickup and an objective lens 2-5 when the tilt correction control means 15 execute the method for determining a gain k in the optical disc device 2010 of the second embodiment.

FIG. 11 is a flowchart illustrating a second determination method for determining a gain k by the tilt correction control means 15 in the optical disc device 2010 of the second embodiment.

FIG. 12 is a diagram illustrating a first relation between gains k and lens shift amounts obtained by the tilt correction control means 15 in the optical disc device 2010 of the second embodiment.

FIG. 13 is a diagram illustrating relations of an output TIC-C of the tilt correction control means 15 and an output TI-C of the microcomputer 10B with lens shift amounts obtained by the objective lens 2-5 in the optical disc device 2010 of the second embodiment.

FIG. 14 is a flowchart illustrating a third determination method of determining a gain k by the tilt correction control means 15 in the optical disc device 2010 of the second embodiment.

FIG. 15 is a diagram illustrating a second relation between gains k and lens shift amounts obtained by the tilt correction control means 15 in the optical disc device 2010 of the second embodiment.

FIG. 16 is a flowchart illustrating a fourth determination method for determining a gain k by the tilt correction control means 15 in the optical disc device 2010 of the second embodiment.

FIG. 17 is a flowchart illustrating a fifth determination method for determining a gain k by the tilt correction control means 15 in the optical disc device 2010 of the second embodiment.

FIG. 18 is a block diagram illustrating an optical disc device 2030 according to the second embodiment of the present invention.

FIG. 19 is a block diagram illustrating an optical disc device 2020 according to a third embodiment of the present invention.

FIG. 20 is a block diagram illustrating an optical disc device 2010′ according to a fourth embodiment of the present invention.

FIG. 21 is a diagram illustrating relations among a seek signal SEEK during seeking operation, a tracking control signal TRON/OFF, and a tilt correction amount TIC-C in the optical disc device 2010′ of the fourth embodiment.

### DESCRIPTION OF REFERENCE NUMERALS

1010 . . . optical disc device

1020 . . . optical disc device

1030 . . . optical disc device

2010 . . . optical disc device

2010′ . . . optical disc device

2020 . . . optical disc device

2030 . . . optical disc device

1 . . . disc

2 . . . pickup

2-1 . . . semiconductor laser

2-2 . . . collimator lens

2-3 . . . deflection beam splitter

2-4 . . . wavelength plate

2-5 . . . objective lens

2-6 . . . detection lens

2-7 . . . reproduction light detector

2-8 . . . tracking actuator

2-9 . . . tilt actuator

2-10 . . . tilt sensor

3 . . . transfer motor

4 . . . tracking detection means

5 . . . tracking control means

6 . . . tracking drive means

7 . . . reproduction signal detection means

8 . . . address detection means

9 . . . jitter detection means

10 . . . microcomputer

10-1 . . . multiplication means

10-2 . . . disc tilt control means

10-3 . . . subtraction means

11 . . . tilt drive means

12 . . . transfer motor drive means

13 . . . light axis deviation detection means

14 . . . tilt detection means

14′ . . . tilt detection means

15 . . . tilt correction control means

16 . . . addition means

17 . . . light axis deviation sensor

18 . . . AD converter

19 . . . DA converter

20 . . . integrated circuit

21 . . . integrated circuit

### BEST MODE TO EXECUTE THE INVENTION

Hereinafter, optical disc devices according to embodiments of the present invention will be described with reference to the attached drawings.

### EMBODIMENT 1

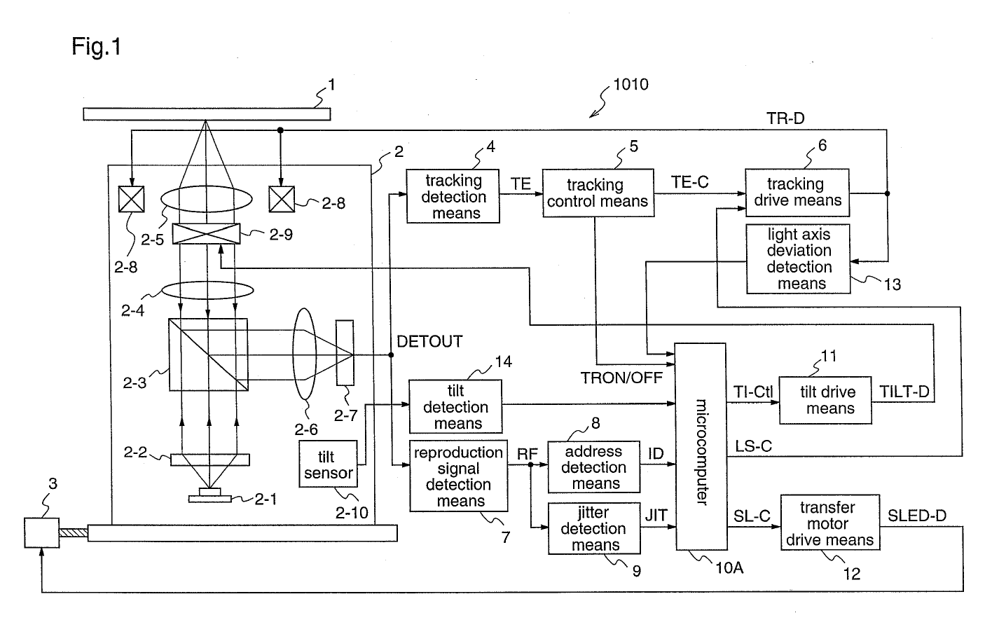

FIG. 1 is a block diagram illustrating an optical disc device 1010 according to a first embodiment of the present invention.

The configuration of the optical disc device 1010 of the first embodiment will be described with reference to FIG. 1.

First of all, in FIG. 1, it is assumed that a Blu-ray Rewritable disc is loaded as an example of a disc 1.

A laser light emitted from a semiconductor laser 2-1 is collimated by a collimator lens 2-2, and the collimated light is transmitted through a deflection beam splitter 2-3 and a wavelength plate 2-4 to be incident on an objective lens 2-5. The laser light incident on the objective lens 2-5 is focused to form a beam spot on the disc 1. The reflected light from the beam spot focused on the disc 1 is again transmitted through the objective lens 2-5 and the wavelength plate 2-4, and separated from the light path of the emission light by the deflection beam splitter 2-3, and then focused on a predetermined light-receiving surface of a reproduction light detector 2-7 through a condensing lens 2-6.

The reflected light focused on the reproduced light detector 2-7 is converted into an electric signal (a DETOUT signal shown in FIG. 1) to be input to a tracking detection means 4. The tracking detection means 4 detects a tracking error signal TE as a track position deviation amount of the beam spot from the track on the disc 1 according to the output DETOUT of the reproduction light detector 2-7, and outputs the signal TE to a tracking control means 5. The tracking control means 5 outputs a drive signal TE-C which performs a control to make the positional deviation of the beam spot from the track on the disc 1 zero, to a tracking drive means 6, on the basis of the tracking error signal TE, and outputs a tracking control signal TRON/OFF which turns tracking on or off, to a microcomputer 10A. The tracking drive means 6 outputs a tracking drive current TR-D to a tracking actuator 2-8 on the basis of the output TE-C from the tracking control means 5. The tracking actuator 2-8 drives the objective lens 2-5 in the direction crossing the track on the disc 1 by the tracking drive current TR-D.

Further, the output DETOUT from the reproduction light detector 2-7 is input to a reproduction signal detection means 7, and the reproduction signal detection means 7 generates a reproduction signal RF. The reproduction signal RF is outputted to an address detection means 8 and to a jitter detection means 9. An output ID of the address detection means 8 is input to a microcomputer 10A, whereby it can be detected where the beam spot focused on the disc 1 by the objective lens 2-5 is positioned on the disc 1. Further, an output JIT of the jitter detection means 9 is also input to the microcomputer 10A. According to the output JIT, the microcomputer 110A can quantitatively detect the reproduction signal characteristics of the data recorded on the disc 1, and the state of the positioning control for the objective lens 2-5.

Further, the microcomputer 10A outputs a transfer control signal SL-C for moving the pickup 2 arbitrarily with respect to the radial direction of the disc 1, to a transfer motor drive means 12. Based on the transfer control signal SL-C, the transfer motor drive means 12 outputs a transfer motor drive signal SLED-D for driving the transfer motor 3 to the transfer motor 3. Based on the transfer motor drive signal SLED-D, the transfer motor 3 transfers the pickup 2 to an arbitrary position in the disc radial direction.

Subsequently, an angular difference (hereinafter referred to as a disc tilt) including warpage of the disc 1 with respect to the objective lens 2-5 is detected by a tilt sensor 2-10 which is embedded in the pickup 2. As for the tilt sensor 2-10 for detecting warpage of the disc 1, since various kinds of such sensors have practically been used, description thereof will be omitted. The output of the tilt sensor 2-10 is input to the microcomputer 10A through the tilt detection means 14. Further, a light axis deviation detection means 13 detects a light axis deviation of the beam spot focused by the objective lens 2-5 using the output of the tracking drive means 6, and outputs the same to the microcomputer 10A. Based on these outputs, the microcomputer 10A outputs a control signal TI-Ctl for controlling a disc tilt, a tilt of the objective lens 2-5 due to a the light axis deviation, and a coma aberration, to a tilt drive means 11. Based on the control output TI-Ctl outputted from the microcomputer 10A, the tilt drive means 11 outputs a drive current TILT-D to a tilt actuator 2-9. Based on the drive current TILT-D from the tilt drive means 11, the tilt actuator 2-9 drives the objective lens 2-5 so as to tilt the objective lens toward the inner circumference or the outer circumference in the radial direction of the disc 1.

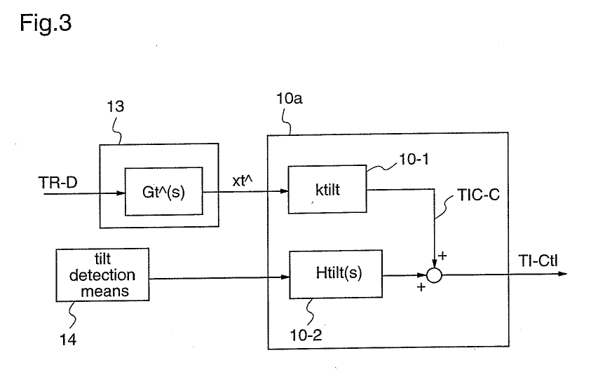

FIG. 3 is a block diagram specifically illustrating the light axis deviation detection means 13, the tilt detection means 14, and the microcomputer 10A which are included in the optical disc device 1010 of the first embodiment. In FIG. 3, a microcomputer 10a is an example of the microcomputer 10A of FIG. 1.

A disc tilt detected by the tilt sensor 2-10 is input to the tilt detection means 14. The output TR-D from the tracking drive means 6 is input to the light axis deviation detection means 13. The light axis deviation detection means 13 is composed of a filter having a transfer function Gt̂(s) that is equal to a dynamic characteristic Gt(s) of the tracking actuator 2-8. That is, an output xt̂ from the light axis deviation detection means 13 is an output obtained by estimating a lens shift amount of the objective lens 2-5.

The output from the light axis deviation detection means 13 is input to a multiplication means 10-1 in the microcomputer 10a.

The output from the tilt detection means 14 is input to a disc tilt control means 10-2. The disc tilt control means 10-2 performs filtering based on the output of the tilt detection means 14 so as to approximate a tilt due to the disc 1 and the objective lens 2-5 to zero, thereby calculating a disc tilt control output TI-C. The transfer characteristic of the disc tilt control means 10-2 is Htilt(s), and the control band is desired to be about the motor rotation frequency.

Subsequently, the output TIC-C of the multiplication means 10-1 is added to the output TI-C of the disc tilt control means 10-2, and the result of the addition is output to the tilt drive means 11 as a control output TI-Ctl.

A predetermined gain Ktilt of the multiplication means 10-1 is given as a design value of a tilt which is obtained by approximating, with a linear function, a ratio of the control signal TI-Ctl which can optimize an output JIT of the jitter detection means 9 with respect to the light axis deviation under the state where the disc tilt is controlled.

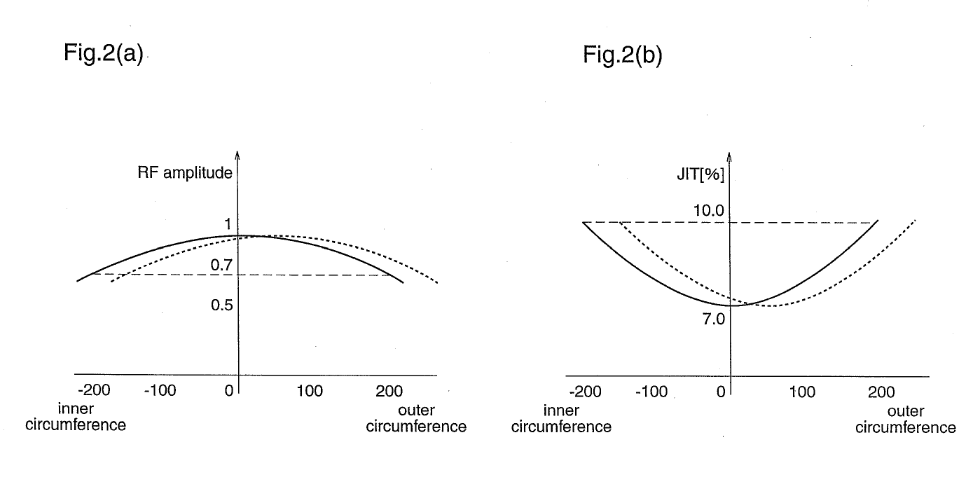

Next, the reproduction signal characteristics obtained when a light axis deviation of the beam spot focused by the objective lens 2-5 occurs will be described with reference to FIG. 2.

FIG. 2 is a diagram illustrating the amplitude of the output RF from the reproduction signal detection means 7 (2(a)) and the characteristics of the output JIT from the jitter detection means 9 (2(b)) with respect to the light axis deviation of the beam spot focused by the objective lens 2-5, respectively.

When the light axis deviation of the beam spot focused by the objective lens 2-5 is near zero, the objective lens 2-5 itself does not tilt, and the coma aberration in the pickup is almost zero. Therefore, the RF amplitude as the output of the reproduction signal detection means 7 is near the maximum value as shown by a solid line in FIG. 2(a). Further, the RF signal amplitude has no remarkable change, and no signal distortion occurs, and therefore, the output JIT of the jitter detection means 9 is hardly different from the optimum (minimum) value as shown by a solid line in FIG. 2(b).

If the objective lens 2-5 shifts from this state toward the inner circumference or the outer circumference and thereby a light axis deviation occurs, the objective lens 2-5 tilts toward the inner circumference or the outer circumference of the disc, and thereby the RF signal amplitude is reduced as shown by a broken line in FIG. 2(a). Further, the jitter JIT of the RF signal detected by the jitter detection means 9 is also degraded as shown by a broken line in FIG. 2(b).

To the contrary, in the optical disc device 1010 of this first embodiment, if a light axis deviation occurs as described above, the amplitude of the reproduction signal RF and the output JIT of the jitter detection means 9 have the characteristics shown by the solid lines in FIGS. 2(a) and 2(b), respectively, by optimizing the control signal TI-Ctl to be outputted from the microcomputer 10A.

To be specific, with respect to the disc tilt, an error signal detected by the tilt sensor 2-10 is controlled by the disc tilt control means 10-2 included in the microcomputer 10a through the tilt detection means 14, thereby to calculate a disc tilt control output TI-C. Further, with respect to the influence of tilt of the objective lens 2-5 which is caused by the light axis deviation or the coma aberration, a light axis deviation is detected by estimating a lens shift amount of the objective lens 2-5 by the light axis deviation detection means 13, and the multiplication means 10-1 in the microcomputer 10a calculates a tilt correction amount TIC-C by multiplying the output of the light axis deviation detection means 13 by a predetermined gain Ktilt. Then, the tilt correction amount TIC-C outputted from the multiplication means 10-1 and the output TI-C of the disc tilt control means 10-2 are added to each other to output a control signal TI-Ctl, thereby performing a control to suppress the influences of the disc tilt, the tilt of the objective lens 2-5 due to the light axis deviation, and the coma aberration of the pickup.

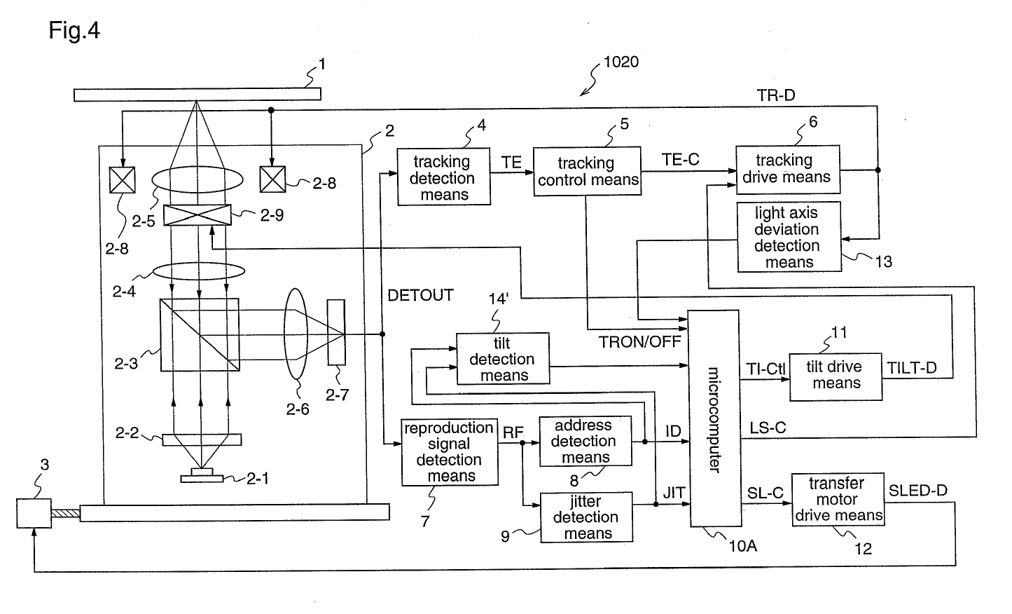

FIG. 4 is a block diagram illustrating an optical disc device 1020 according to the first embodiment of the present invention. The same constituents of the optical disc device 1020 as those of the optical disc device 1010 are given the same reference numerals to omit the description thereof.

In the optical disc device 1020 shown in FIG. 4, a tilt detection means 14′ for detecting a disc tilt receives, as input signals, the output ID of the address detection means 8 and the output JIT of the jitter detection means 9. The tilt detection means 14′ previously obtains a control output TI-Ctl of the microcomputer 10A, which optimizes the jitter of the reproduction signal RF at an arbitrary disc radial position, and stores the value in a table.

The light axis deviation detection means 13 estimates a lens shift amount of the objective lens 2-5 as a light axis deviation, and outputs the same to the microcomputer 10A, as in the optical disc device 1010.

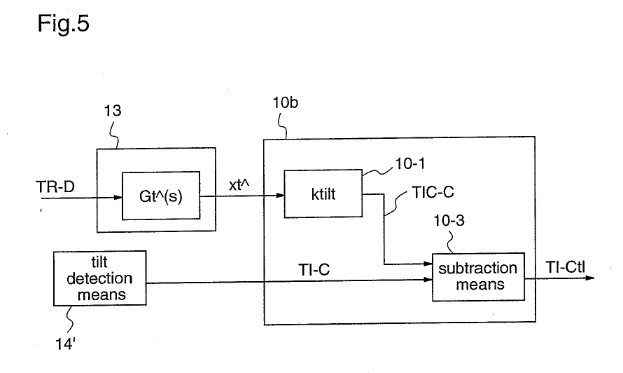

FIG. 5 is a block diagram specifically illustrating the light axis deviation detection means 13, the tilt detection means 14′, and the microcomputer 10A in the optical disc device 1020 of the first embodiment. In FIG. 5, a microcomputer 10b is an example of the microcomputer 10A shown in FIG. 4.

As shown in FIG. 5, in the microcomputer 10b, a subtraction means 10-3 performs a subtraction between a signal TIC-C which is obtained by multiplying the output of the light axis deviation detection means 13 by a predetermined gain ktilt, and the output TI-C of the tilt detection means 14′, and outputs the result of the subtraction as a control signal TI-Ctl to the tilt drive means 11.

The table stored in the tilt detection means 14′ can be defined by an arbitrary radial position. For example, when the number of tables is 1, a disc tilt control signal is outputted with a unique value for the entire disc radial area. When the number of tables is two or more, a disc radial position and a control signal TI-Ctl which optimizes the jitter of the reproduction signal RF at the radial position are previously entered in the tables, whereby the disc radial position is detected according to the output of the address detection means 8 and a control signal can be outputted so as to follow the disc tilt.

While in the optical disc device 1020 the light axis deviation detection means 13 is configured to estimate and detect the lens shift amount of the objective lens 2-5 from the output TR-D of the tracking device means 6, it may be configured by a sensor for detecting the lens shift amount of the objective lens 2-5, and also in this case, the same control as described above can be carried out.

Further, the light axis deviation of the objective lens 2-5 may be generated from the output DETOUT of the reproduction light detector 2-7.

While in the optical disc device 1020 the output JIT of the jitter detection means 9 is used as a signal for determining the tilt drive signal TILT-D which drives the tilt actuator 2-9, the amplitude of the output RF of the reproduction signal detection means 7 may be used with the same effect as described above.

Further, the microcomputer 10A shown in FIG. 1 or 4 may have the configuration of the microcomputer 10a shown in FIG. 3 or the microcomputer 10b shown in FIG. 5.

A portion of the configuration of the optical disc device 1010 shown in FIG. 1 may be configured by an integrated circuit 20 as described below.

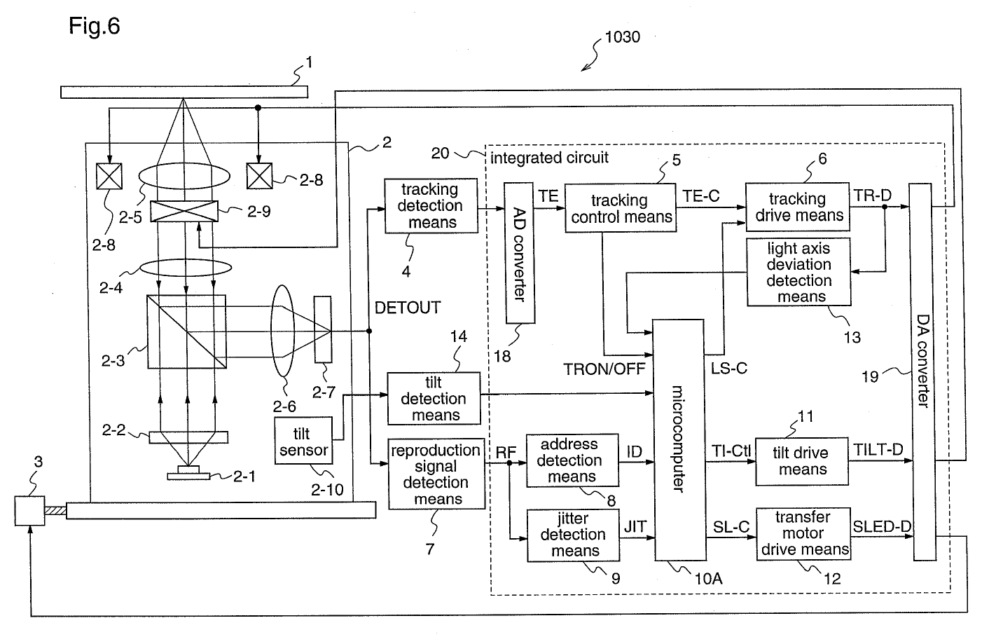

FIG. 6 is a block diagram illustrating an optical disc device 1030 including an integrated circuit 20 according to the first embodiment of the present invention. In the optical disc device 1030, the same constituents as those of the optical disc device 1010 are given the same reference numerals to omit the description thereof.

In the optical disc device 1030 shown in FIG. 6, a tracking control system comprising an AD converter 18 for converting an analog signal from the tracking detection means 4 into a digital signal, a tracking control means 5, and a tracking drive means 6 is configured by digital control, and a tilt control system comprising an address detection means 8, a jitter detection means 9, a microcomputer 10A, a light axis deviation detection means 13, a tilt drive means 11, and a transfer motor drive means 12 is also configured by a digital control, and the outputs from the tracking drive means 6, the tilt drive means 11, and the transfer motor drive means 12 are converted into analog signals by a DA converter 19, and further, these functions are integrated to be configured as an integrated circuit 20.

The functions of the tracking control means 5, the light axis deviation detection means 13, and the microcomputer 10A may be configured by a tilt control program.

As described above, the optical disc device of the first embodiment is provided with the light axis deviation detection means 13 which detects a light axis deviation of light emitted from the objective lens which focuses a light beam on the optical disc, the tilt detection means 14 which detects a warpage of the optical disc, and the microcomputer 10A which controls a tilt of the objective lens on the basis of the output of the light axis deviation detection means 13 and the output of the tilt detection means 14. Therefore, if a reflection light which is incident on the reproduction light detector is deteriorated by a tilt of the objective lens or a coma aberration which occurs due to a light axis deviation caused by a lens shift of the objective lens when recording data on the recording medium or reproducing data from the recording medium, the tilt of the objective lens is controlled considering the influence of the disc warpage and the influence by the light axis deviation, whereby degradation of the reproduction signal based on the reflection light from the recording medium can be suppressed, and thus accurate data recording or reproduction can be carried out.

### EMBODIMENT 2

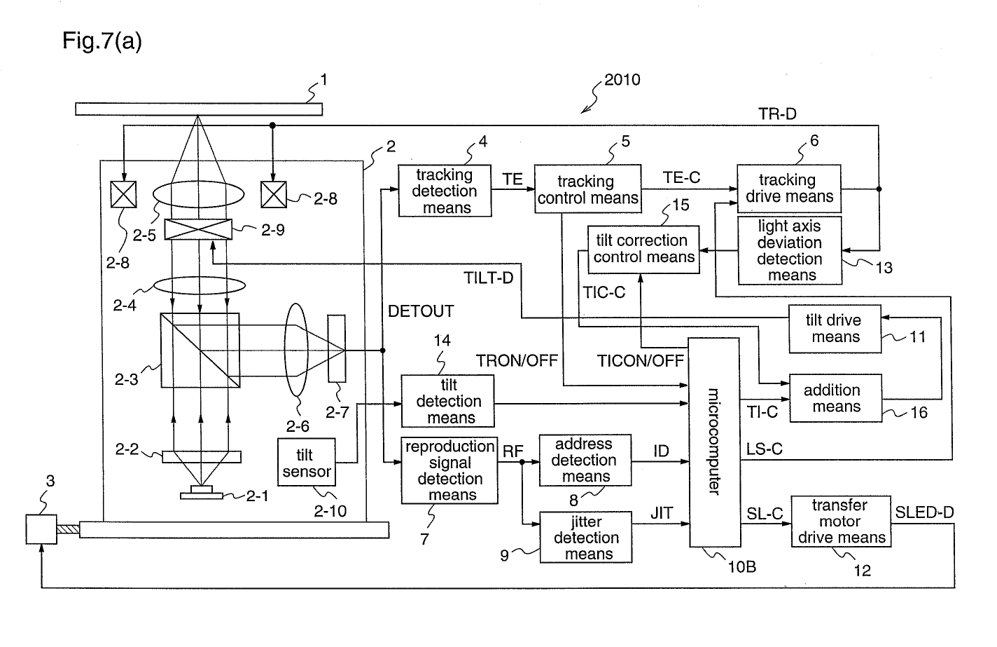

FIG. 7(a) is a block diagram illustrating an optical disc device 2010 according to a second embodiment of the present invention.

The configuration of the optical disc device 2010 of the second embodiment will be described with reference to FIG. 7(a). In FIG. 7(a), the same constituents as those of the optical disc device 1010 shown in FIG. 1 are given the same reference numerals to omit the detailed description thereof.

In the optical disc device 2010 shown in FIG. 7(a), a tilt correction control means 15 is an element which is provided for correcting a deterioration of a reproduction signal if the objective lens 2-5 shifts and thereby a light axis deviation occurs when recording or reproducing data in or from the disc 1, in cooperation with the light axis deviation detection means 13 which detects a light axis deviation of the objective lens 2-5.

That is, the tilt correction control means 15 calculates and outputs a tilt correction amount TIC-C for the objective lens 2-5 on the basis of an output of the light axis deviation detection means 13, in order to correct a tilt of the objective lens 2-5 and an influence of a coma aberration, which are caused by lens shift of the objective lens 2-5. The tilt correction amount TIC-C is input to an addition means 16.

A control signal TICON/OFF is outputted from the microcomputer 10B to the tilt correction control means 15.

The TICON/OFF signal is a signal for controlling ON/OFF of the tilt correction control. For example, when tracking control is OFF (signal TRON/OFF is OFF) or when tilt correction control described later is not necessary, tilt correction control is stopped by the TICON/OFF signal.

The detail of the tilt correction control will be described later.

The tilt sensor 2-10 embedded in the pickup 2 detects a warpage of the disc 1, i.e., a disc tilt, and outputs the disc tilt amount to the microcomputer 10B through the tilt detection means 14. The output of the tilt detection means 14 which is input to the microcomputer 10B is filtered so that a tilt due to the disc 1 and the objective lens 2-5 which is caused by the disc tilt is approximated to zero, and a control output TI-C is calculated to be outputted to the addition means 16. That is, the microcomputer 10B has a function as a tilt control means for controlling the tilt of the objective lens 2-5 in accordance with the warpage of the optical disc 1.

The configuration of the microcomputer 10B which serves as the tilt control means for controlling a tilt of the objective lens 2-5 according to a warpage of the optical disc will be described with reference to FIG. 7(b).

FIG. 7(b) is a block diagram illustrating the configuration of the microcomputer 10B in the optical disc device 2010 of the second embodiment. An output of the tilt detection means 14 is input to the disc tilt control means 10-2. The disc tilt control means 10-2 performs filtering so as to approximate a tilt due to the disc 1 and the objective lens 2-5 to zero, and calculates a control output TI-C to output the same to the addition means 16. The transfer characteristic of the disc tilt control means 10-2 is Htilt(s), and the control band is desired to be about the motor rotation frequency.

The addition means 16 adds the output TIC-C of the tilt correction control means 15 and the output TI-C of the microcomputer 10B to output a control signal TI-Ctl to the tilt drive means 11. That is, the addition means 16 is one for adding the control signal TIC-C which controls the influence of a coma aberration or atilt of the objective lens 2-5 due to a light axis deviation, and the control signal TI-C which controls a disc tilt.

The tilt drive means 11 outputs a signal TILT-D for driving the tilt actuator 2-9 to the tilt actuator 2-9 on the basis of the output of the addition means 16. The tilt actuator 2-9 drives the objective lens 2-5 on the basis of the drive signal TILT-D from the tilt drive means 11.

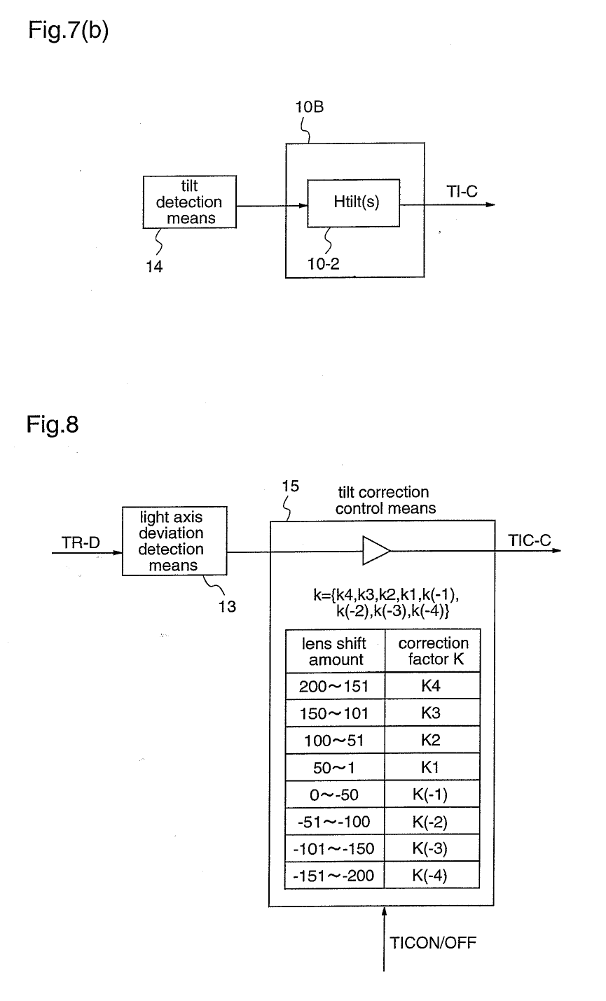

Next, tilt correction control associated with light axis deviation, which is performed by the light axis deviation detection means 13 and the tilt correction control means 15, will be described with reference to FIG. 8.

FIG. 8 is a block diagram for explaining the configurations of the light axis deviation detection means 13 and the tilt correction control means 15 for performing tilt correction control associated with light axis deviation in the optical disc device 2010 of the second embodiment.

Initially, as already described with reference to FIG. 3, the light axis deviation detection means 13 is configured by a filter having a transfer function Gt̂(s) that is equivalent to a dynamic characteristic Gt(s) of the tracking actuator 2-8. Accordingly, the light axis deviation detection means 13 receives the output TR-D from the tracking drive means 6, and estimates and detects the positional information of the tracking actuator 2-8.

The output from the light axis deviation detection means 13 is input to the tilt correction control means 15.

The tilt correction control means 15 multiples the output of the light axis deviation detection means 13 by a predetermined gain k, and outputs a tilt correction amount TIC-C to the addition means 16. The predetermined gain k is variable according to the light axis deviation amount of the objective lens 2-5.

Generally, when the light axis deviation amount of the objective lens 2-5 is small, the influences of the tilt amount and the coma aberration are small or negligible. However, the tilt amount or the coma aberration tends to increase as the light axis deviation amount becomes larger.

In the optical disc device 2010 of the second embodiment, a countermeasure against such characteristics is realized by the configuration comprising the light axis deviation detection means 13 and the tilt correction control means 15 shown in FIG. 8.

In the configuration comprising the light axis deviation detection means 13 and the tilt correction control means 15 shown in FIG. 8, the tilt correction control means 15 has a table which is configured so that the predetermined gain k by which the output of the light axis deviation detection means 13 is multiplied can be varied every time the objective lens 2-5 is shifted by 50 μm.

That is, the predetermined gain k is k4 when the lens shift amount of the objective lens 2-5 is in a range from 200 μm to 151 μm, the predetermined gain k is k3 when the lens shift amount of the objective lens 2-5 is in a range from 150 μm to 101 μm, the predetermined gain k is k2 when the lens shift amount of the objective lens 2-5 is in a range from 100 μm to 51 μm, the predetermined gain k is k1 when the lens shift amount of the objective lens 2-5 is in a range from 50 μm to 1 μm, the predetermined gain k is k(−1) when the lens shift amount of the objective lens 2-5 is in a range from 0 μm to −50 μm, the predetermined gain k is k(−2) when the lens shift amount of the objective lens 2-5 is in a range from −51 μm to −100 μm, the predetermined gain k is k(−3) when the lens shift amount of the objective lens 2-5 is in a range from −101 μm to −150 μm, and the predetermined gain k is k(−4) when the lens shift amount of the objective lens 2-5 is in a range from −151 μm to −200 μm.

Further, while in the optical disc device 2010 the gains k are set at the eight points of k4, k3, . . . , k(−3), k(−4), the present invention is not restricted thereto, and the gains k may be arbitrarily set at two or more points.

As already described, the control signal TICON/OFF is outputted from the microcomputer 10B to the tilt correction control means 15, and this control signal TICON/OFF is switchingly outputted so as to turn off the tilt correction control when it is not necessary, and thereby the predetermined gain k is made zero to stop the tilt correction control.

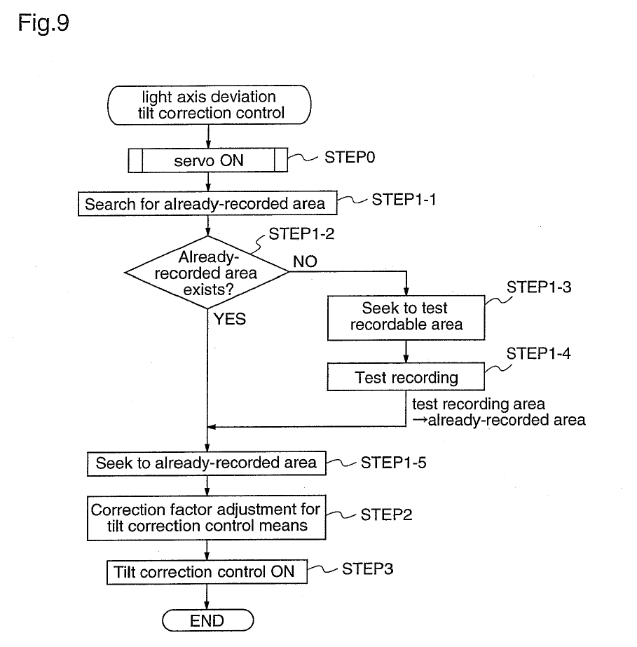

Next, a description will be given of a first method and a second method for determining k4, k3, . . . , k(−3), k(−4) which are the components of the predetermined gain k, with reference to FIGS. 9, 10, and 11.

FIG. 9 is a flowchart illustrating an algorithm of the first method for determining k4, k3, . . . , k(−3), and k(−4) which are the components of the predetermined gain k in the optical disc device 2010 of the second embodiment.

Initially, the optical disc device 2010 shown in FIG. 7(a) drives the disc 1 at a predetermined number of rotations, the semiconductor laser 2-1 outputs a light beam for reproducing data from the disc 1, and the objective lens 2-5 focuses a beam spot on the track of the disc 1.

Next, although it is not shown in FIG. 7(a), the focus position is controlled so as to focus the beam spot on the recording surface of the disc 1, and further, the beam spot is focused onto a point near the center position of the track on the disc 1 by the tracking control means 5, i.e., servo ON is performed (hereinafter referred to as STEP0), and subsequently, searching for an already recorded area on the disc 1 is carried out. For example, such as a recording information management area which is defined in the DVD disc or Blu-ray disc standard is reproduced to detect whether a track on which data has already been recorded exists or not (STEP 1-1).

Next, it is judged whether an already recorded area exists on the disc 1 or not (STEP 1-2). If there is no recorded area (NO in STEP1-2), the beam spot is moved to a test recording capable area to form a recorded track (STEP1-3). For example, the beam spot may be moved to a power correction area (PCA) of a DVD disc or a Blu-ray disc as a test recording available area.

Subsequently, test recording is performed to the test recording capable area (STEP1-4).

Thereby, an area for determining the gain k can be formed even when no recorded area exists on the disc 1, for example, when a blank disc is loaded.

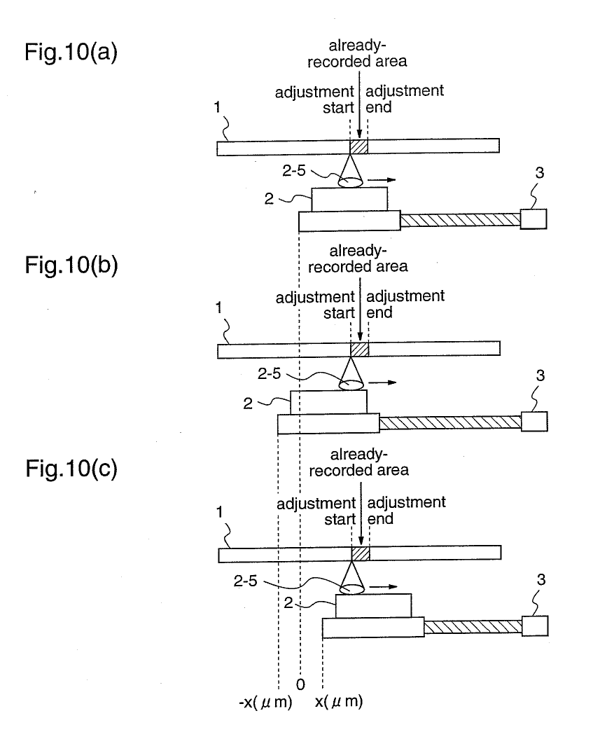

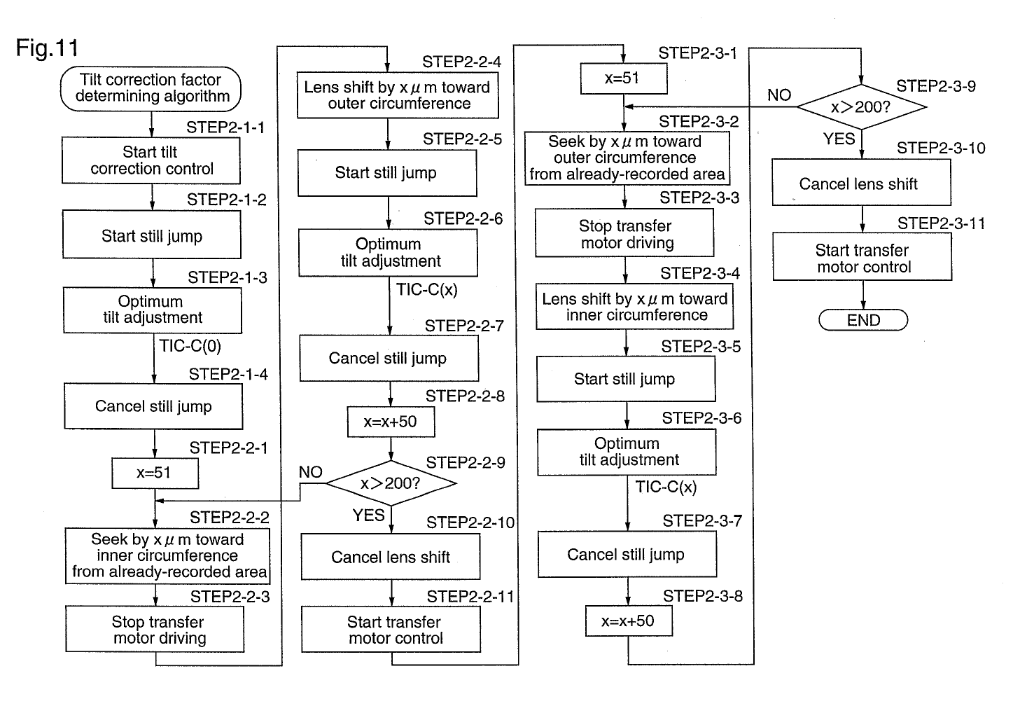

Subsequently, the beam spot is moved to the recorded area on the disc 1 (STEP1-5). Then, the jitter of the data in the recorded area is measured to determine the components k4, k3, k(−3), and k(−4) of the gain k of the tilt correction control means 15 (STEP2). The specific method for determining the gain k will be later described using FIGS. 10 and 11.

After the components k4, k3, . . . , k(−3), and k(−4) of the gain k are determined, the microcomputer 10B switches the TICON/OFF signal to turn on tilt correction control, thereby to execute tilt correction control for the objective lens 2-5 associated with light axis deviation (STEP3).

Subsequently, the method for determining the gain k in STEP2 in FIG. 9 will be specifically described with reference to FIGS. 10 and 11.

FIG. 10 is a schematic diagram illustrating the positional relation between the pickup 2 and the objective lens 2-5 when the tilt correction control means 15 determines the components k4, k3, . . . , k(−3), k(−4) of the gain k in the optical disc 2010 of the second embodiment, and FIG. 11 is a diagram illustrating a flowchart of the second method for determining the components k4, k3, . . . , k(−3), k(−4) of the gain k by the tilt correction control means 15.

In FIG. 11, initially, the microcomputer 10B outputs a TICON/OFF control signal indicating “tilt correction control ON” to the tilt correction control means 15 (STEP2-1-1).

Subsequently, still jump of the beam spot is started with the beam spot being moved to the already recorded area. That is, the beam spot is position-controlled in a section between an arbitrary base point of the recorded track on the disc 1 and the adjacent one track or a few tracks (STEP2-1-2). Consequently, as shown in FIG. 10(a), the beam spot can be controlled under the state where the light axis deviation amount is near zero.

Next, optimum tilt adjustment is executed under the state where the light axis deviation is near zero. Here, the jitter of the track which is position-controlled in STEP2-1-2 is measured, and a tilt correction amount TIC-C with which the jitter is minimized is detected to be stored as TIC-C (0) (STEP2-1-3).

Subsequently, the still jump is canceled (STEP2-1-4), and variables of the tilt correction control means 15 and the microcomputer 10B are set so that the light axis deviation toward the outer circumference becomes 51 μm (STEP2-2-1).

Next, the microcomputer 10B transfers the transfer motor 3 by 51 μm toward the inner circumference from the recorded area in which the optimum tilt adjustment has been performed in STEP2-1-3, using the transfer motor drive means 12 (STEP2-2-2), and then stops the driving of the transfer motor (STEP2-2-3).

Subsequently, the microcomputer 10B outputs a lens shift drive signal LS-C to the objective lens 2-5 through the tracking drive means 6 so as to control the beam spot position onto the track for which the optimum tilt adjustment has been performed in STEP2-1-3. According to the lens shift drive signal LS-C, the tracking actuator 2-8 drives the objective lens 2-5 to be shifted by 51 μm toward the outer circumference (STEP2-2-4).

Next, as in STEP2-1-2, still jump is started (STEP2-2-5). That is, as shown in FIG. 10(b), while the beam spot is position-controlled onto the same track as in STEP2-1-3, the light axis is controlled to be shifted by 51 μm toward the outer circumference. As the result, while the light axis deviation amount is shifted by 51 μm toward the outer circumference as shown in FIG. 10(b), the beam spot can be controlled to near the same position as the adjustment start position shown in FIG. 10(a).

Subsequently, as in STEP2-1-3, optimum tilt adjustment is executed in the state where the light axis deviation amount is shifted by 51 μm toward the outer circumference. Here, the jitter at the track which is position-controlled in STEP2-2-5 is measured, and a tilt correction amount TIC-C which minimizes the jitter is detected to be stored as TIC-C (51). Then, a value obtained by dividing a difference between the tilt correction amount TIC-C(0) detected in STEP2-1-3 and the TIC-C(51) by the lens shift amount of 51 μm is set in a table as a predetermined gain k1 (STEP2-2-6).

Next, the still jump is again canceled (STEP2-2-7), and variables of the tilt correction control means 15 and the microcomputer 10B are set so that another 50 μm is further added to the value of the light axis deviation amount which is set in STEP2-2-1 (STEP2-2-8).

When the variable of the light axis deviation amount which is set in STEP2-2-8 exceeds 200, STEP2-2-2 and the subsequent steps are repeatedly executed according to the variable of the light axis deviation amount. By repeating the steps, the tilt correction control means 15 detects the tilt correction amount TIC-C(x) which minimizes the jitter to the lens shift amount x, and calculates a ratio between the lens shift amount x and the tilt correction amount TIC-C(x) which controls the tilt of the objective lens to determine the components k1, k2, k3, and k4 of the gain k. Thus determined components k1, k2, k3, and k4 are set in a table as shown in FIG. 8.

After the gain components k1, k2, k3, and k4 for tilt correction control against the light axis deviation toward the outer circumference are determined, a step of determining the gain components toward the inner circumference is executed.

Initially, the drive signal LS-C for shifting the objective lens 2-5 is set to zero to cancel lens shift (STEP2-2-10), and the driving stop of the transfer motor 3 which is stopped in STEP2-2-3 is canceled to restart control (STEP2-2-11).

Subsequently, variables of the tilt correction control means 15 and the microcomputer 10B are set so that the light axis deviation amount becomes 51 μum toward the inner circumference (STEP2-3-1), and the beam spot is moved by 51 μm toward the outer circumference from the recorded track for which the optimum tilt adjustment has been performed in STEP2-1-3 and STEP2-2-6 (STEP2-3-2), and the driving of the transfer motor 3 is again stopped (STEP2-3-3).

Next, the microcomputer 10B outputs a drive signal LS-C for shifting the objective lens 2-5 through the tracking drive means 6 so as to move the objective lens 2-5 to the same track as the track for which the optimum tilt adjustment has been executed in STEP2-1-3 and STEP2-2-6 (STEP2-3-4).

Here, still jump is started to determine the position of the beam spot onto the track to be subjected to optimum tilt adjustment (STEP2-3-5). As the result, as shown in FIG. 10(c), the beam spot can be controlled to near the same position as the adjustment start position shown in FIG. 10(a) although the light axis deviation amount is shifted by 51 μm toward the inner circumference.

Then, as in STEP2-1-3 and STEP2-2-6, optimum tilt adjustment is executed in the state where the light axis deviation amount is shifted by 51 μm toward the inner circumference. Here, the jitter at the track which is position-controlled in STEP2-3-5 is measured, and a tilt correction amount TIC-C which minimizes the jitter is detected to be stored as TIC-C(-51). Then, a value obtained by dividing a difference between the tilt correction amount TIC-C(0) detected in STEP2-1-3 and TIC-C(-51) by the lens shift amount of 51 μm is set in the table with the predetermined gain k being k(−1) (STEP2-3-6).

Next, still jump is canceled (STEP2-3-7), and variables of the tilt correction control means 15 and the microcomputer 10B are set so that another 50 μm is added to the light axis deviation amount which is set in STEP2-3-1 (STEP2-3-8).

When the variable of the light axis deviation amount which is set in STEP2-3-8 exceeds 200 (NO in STEP2-3-8), STEP2-3-2 and the subsequent steps are repeated according to the variable of the light axis deviation amount. By repeating the steps, the tilt correction control means 15 detects a tilt correction amount TIC-C(x) which minimizes the jitter to the lens shift amount x, and calculates a ratio between the lens shift amount x and the tilt correction amount TIC-C(x) for controlling the tilt of the objective lens, thereby to determine the components k(−2), k(−3), and k(−4) of the gain k (STEP2-3-9). Thus determined gain components k(−1), k(−2), k(−3), and k(−4) are set in the table as shown in FIG. 8.

After the gain components k(−1), k(−2), k(−3), and k(−4) for tilt correction control against the light axis deviation toward the inner circumference are determined, the drive signal LS-C for shifting the objective lens 2-5 is set to zero to cancel the lens shift (STEP2-3-10), and driving stop of the transfer motor 3 which is stopped in STEP2-3-3 is canceled to restart control (STEP2-3-11).

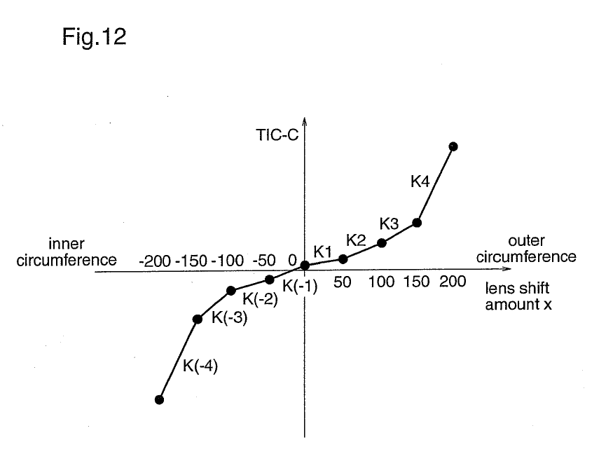

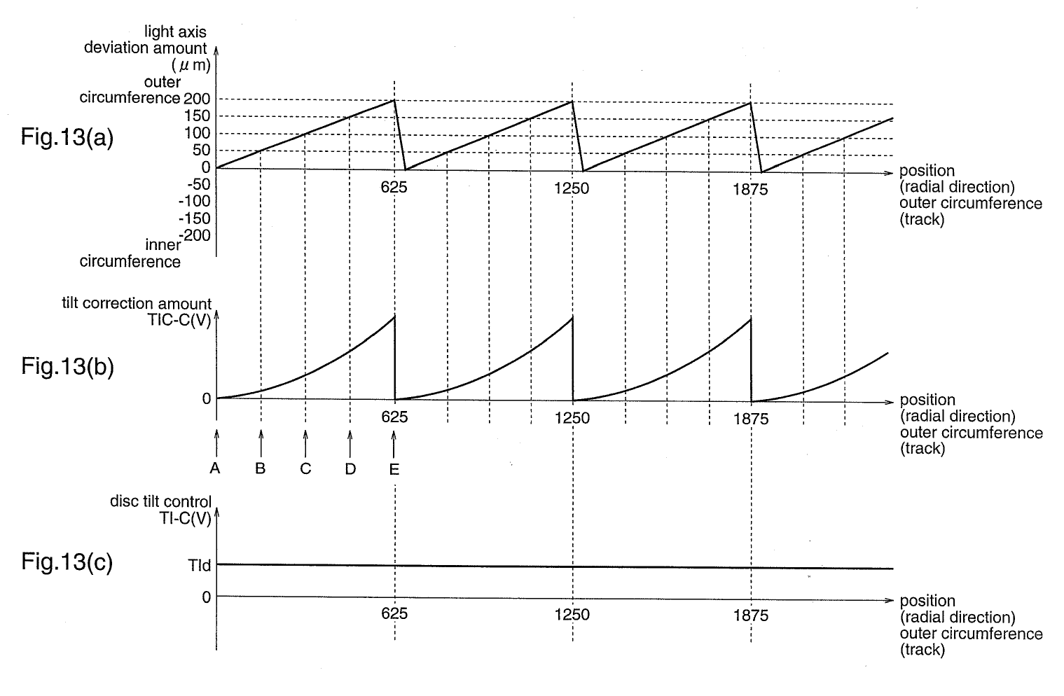

Subsequently, a description will be given of the light axis deviation amount due to the objective lens 2-5, the tilt correction amount TIC-C, and the disc tilt control output TI-C which are obtained when the optical disc device 2010 shown in FIG. 7(a) reproduces or records data from or in the disc 1, with reference to FIGS. 12 and 13.

FIG. 12 is a graph which plots the gains k determined by the tilt correction control means 15 for correcting a tilt or a coma aberration that is caused by a light axis deviation due to a lens shift of the objective lens 2-5 in the optical disc device 2010 of the second embodiment.

In FIG. 12, the abscissa shows the lens shift amounts, and the lens shift amounts toward the outer circumference are notified by positive numbers while those toward the inner circumference are notified by negative numbers. The ordinate shows the predetermined gains k. In FIG. 12, a gain k is determined for each lens shift amount of 50 μm, and the determined gains for the lens shift amounts are k(−4), k(−3), k(−2), k(−1), k(1), k(2), k(3), and k(4).

When STEP 3 described with FIG. 9 is executed, tilt correction control is executed. When the optical disc device 2010 shown in FIG. 7(a) records data in the disc 1 or reproduces data from the disc 1, the tilt correction control means 15 outputs a tilt correction amount TIC-C as a light axis deviation correction control output. A description will be given of the light axis deviation amount of the objective lens 2-5, the tilt correction amount TIC-C, and the disc tilt control output TI-C which are obtained when the optical disc device 2010 shown in FIG. 7(a) records data on the disc 1, with reference to FIG. 13.

FIG. 13 is a diagram illustrating the relations of the output TIC-C from the tilt correction control means 15 and the output TI-C of the microcomputer 10B with the lens shift amount of the objective lens 2-5 in the optical disc device 2010 of the second embodiment, wherein the abscissa shows the track on which the beam spot is positioned with the recording start track being a base point.

FIG. 13(a) shows the light axis deviation amount of the objective lens 2-5. It is assumed that the optical disc device 2010 is designed such that the transfer motor 3 is moved by 200 μm toward the outer circumference when the objective lens 2-5 has a light axis deviation of about 200 μm, and simultaneously, the objective lens 2-5 makes the light axis deviation amount zero. FIG. 13(b) shows the tilt correction amount signal TIC-C outputted from the tilt correction control means 15, and FIG. 13(c) shows the disc tilt control signal TI-C outputted from the microcomputer 10B.

The track pitch of the disc 1 which is loaded on the optical disc device 2010 of the second embodiment shown in FIG. 7(a) is 0.32 μm, and a light axis deviation amount of 0.32 μm is added to the objective lens 2-5 every time the disc 1 rotates once.

Accordingly, as shown in FIG. 13(a), when the disc 1 rotates 156 times, the light axis deviation amount becomes 49.92 μm. Likewise, when the disc 1 rotates 625 times, the light axis deviation amount becomes 200 μm, and the microcomputer 10B drives the transfer motor 3 via the transfer motor drive means 12 so as to move the motor 3 by 200 μm toward the outer circumference.

The transfer motor 3 transfers the pickup 2 by 200 μm according to the drive signal SLED-D from the transfer motor drive means 12. Simultaneously, the tracking control means 5 outputs a control signal TE-C to the tracking drive means 6 so as to make the lens shift of the objective lens 2-5 zero, and the tracking drive means 6 outputs a tracking drive signal TR-D according to the TE-C signal from the tracking control means 5 to drive the tracking actuator 2-8. The tracking actuator 2-8 makes the lens shift of the objective lens 2-5 zero.

Further, it is premised that, in the optical disc device 2010 shown in FIG. 7(a), the tilt detection means 14 detects a disc tilt for suppressing an influence of warpage of the loaded disc 1, and the microcomputer 10B outputs a disc tilt control signal TI-C. Here, it is assumed that TId is outputted as the disc tilt control signal TIC over the entire circumference of the disc 1 as shown in FIG. 13(c). Further, the tilt correction control means 15 outputs a tilt correction amount TIC-C on the basis of the output from the light axis deviation detection means 13.

Initially, the optical disc device 2010 shown in FIG. 7(a) starts recording operation with an arbitrary track on the disc 1 being a base point. At the start of recording, the lens shift amount of the objective lens 2-5 is zero.

So, as shown by A in FIG. 13(b), the tilt correction control means 15 sets the gain k at the time when the light axis deviation amount of the objective lens 2-5 is zero, to the gain k(−1) corresponding to the lens shift amount of 0 to −50 μm on the table of the tilt correction control means 15 shown in FIG. 8, and multiplies the output of the light axis deviation detection means 13 by k(−1) to output the result as a tilt correction amount TIC-C.

Since the microcomputer 10 outputs the TId as the disc tilt control output TI-C for controlling a warpage of the disc 1, the addition means 16 adds the tilt correction amount TIC-C and the Tid to output a tilt drive signal TILT-D to the tilt actuator 2-9 through the tilt drive means 11.

Subsequently, when the disc 1 is rotated four times with the recording start being a base point, the beam spot is controlled to the position of 1.28 μm with the recording start track being a base point, and therefore, the tilt correction control means 15 changes the predetermined gain k from k(−1) to k(1) which corresponds to the lens shift amount of 50 to 1 μm on the table of the tilt correction control means 15 shown in FIG. 8. Then, the tilt correction control means 15 multiplies the output of the light axis deviation detection means 13 by k(1) to output a tilt correction amount TIC-C.

Next, as shown by B in FIG. 13(b), when the disc 1 is rotated 160 times with the recording start being a base point, the beam spot is controlled to the position of 51.2 μm with the recording start track being a base point, and therefore, the tilt correction control means 15 changes the predetermined gain k from k(1) to k(2) which corresponds to the lens shift amount of 100 to 51 μm on the table of the tilt correction control means 15 shown in FIG. 8. Then, the tilt correction control means 15 multiplies the output of the light axis deviation detection means 13 by k(2) to output a tilt correction amount TIC-C.

Subsequently, as shown by C in FIG. 13(b), when the disc 1 is rotated 316 times with the recording start being a base point, the beam spot is controlled to the position of 101.12 μm with the recording start track being a base point, and therefore, the tilt correction control means 15 changes the predetermined gain k from k(2) to k(3) which corresponds to the lens shift amount of 150 to 101 μm on the table of the tilt correction control means 15 shown in FIG. 8. Then, the tilt correction control means 15 multiplies the output of the light axis deviation detection means 13 by k(3) to output a tilt correction amount TIC-C.

Likewise, as shown by D in FIG. 13(b), when the disc 1 is rotated 472 times with the recording start being a base point, the beam spot is controlled to the position of 151.04 μm with the recording start track being a base point, and therefore, the tilt correction control means 15 changes the predetermined gain k from k(3) to k(4) which corresponds to the lens shift amount of 200 to 151 μm on the table of the tilt correction control means 15 shown in FIG. 8. Then, the tilt correction control means 15 multiplies the output of the light axis deviation detection means 13 by k(4) to output a tilt correction amount TIC-C.

Thereafter, when the disc 1 is rotated by 625 times with the recording start as a base point, the objective lens 2-5 is controlled to the position of 200 μm with the recording start track as a base point, and the light axis deviation amount becomes 200 μm, and therefore, the microcomputer 10B outputs a transfer control signal SL-C to the transfer motor drive means 12 so as to move the transfer motor 3 by 200 μm toward the outer circumference. The transfer motor drive means 12 outputs a drive signal SLED-D for transferring the transfer motor 3 to the transfer motor 3 on the basis of the SL-C signal from the microcomputer 10B. As the result, the transfer motor 3 is moved by 200 μm toward the outer circumference.

Simultaneously, the tracking control means 5 outputs a tracking control signal TE-C so as to make the lens shift amount of the objective lens 2-5 zero. The tracking drive means 6 outputs a tracking drive signal TR-D to the tracking actuator 2-8 on the basis of the TE-C signal outputted from the tracking control means 5.

Consequently, as shown by E in FIG. 13(b), the outputs of the objective lens 2-5 and the tilt correction control means 15 return to the states at the recording start. Thereafter, the same operation as mentioned above is repeated until the end of recording.

Further, in the state where the tilt of the objective lens with respect to the warpage of the optical disc which is previously detected by the tilt detection means 14 is controlled by the microcomputer 10B, the tilt correction control means 15 may perform tilt correction control for the light axis deviation to output a tilt correction amount TIC-C to the addition means 16.

While in the above description the optical disc device 2010 shown in FIG. 7(a) controls the disc warpage and the objective lens tilt due to the light axis deviation during recording, similar control can be carried out also during reproduction, and thereby the data reproduction performance can be significantly enhanced.

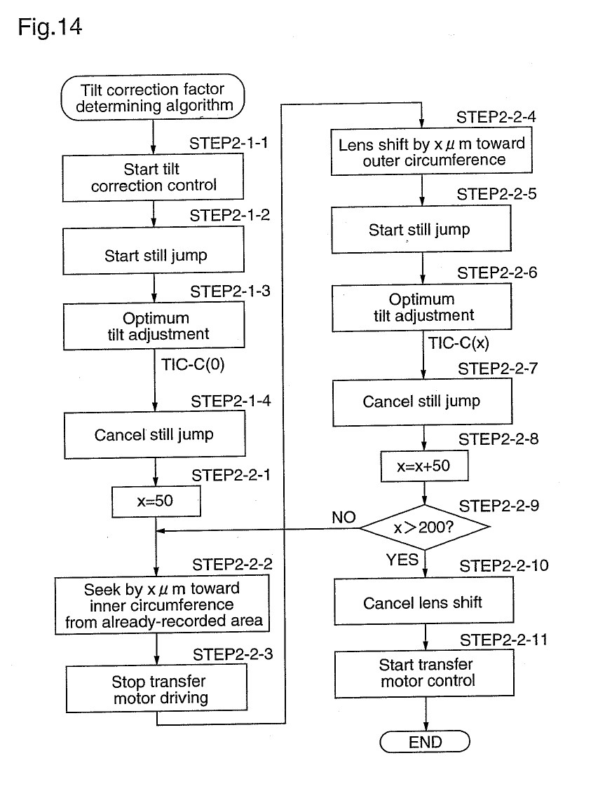

FIG. 14 is a flowchart illustrating the third method of determining the gain k by the tilt correction control means 15 in the optical disc device 2010 of the second embodiment.

When the disc 1 loaded on the optical disc device 2010 shown in FIG. 7(a) has a format for recording data from the inner circumference toward the outer circumference, the method of determining the gain k by the tilt correction control means 15 may be performed only in the state where the objective lens 2-5 is shifted toward the outer circumference as shown in FIG. 14.

That is, only the steps from STEP2-1-1 to STEP2-2-11 shown in FIG. 11 may be executed. Also in this case, the same effect as in the case of determining the gain k by the method shown in FIG. 11 can be obtained when recording or reproducing data in or from the disc 1. Further, in this case, the time required for determining the gain k can be reduced.

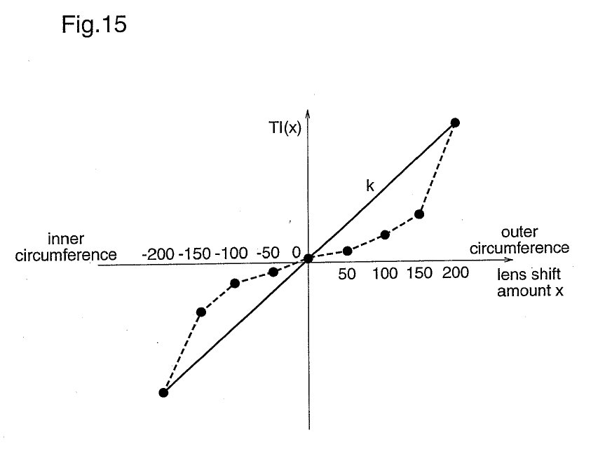

While the predetermined gain k of the tilt correction control means may be variable according to the light axis deviation amount, it may be a predetermined constant as shown in FIG. 15.

FIG. 15 is a diagram illustrating the relation between the gain k and the lens shift amount of the tilt correction control means in the optical disc device 2010 of the second embodiment.

While in FIG. 12 the predetermined gain k is made variable for each 50 μm of the lens shift amount of the objective lens 2-5, as shown in FIG. 15, an optimum tilt adjustment value which is obtained by adjusting the lens shift amount by 200 μm toward the inner circumference (in FIG. 15, the direction toward the inner circumference is notified by negative numbers) and an optimum tilt adjustment value which is obtained by adjusting the lens shift amount by 200 μm toward the outer circumference may be approximated by a first-order straight line, and its inclination may be used as a predetermined gain k.

By adopting the above-described configuration, the structure of the tilt correction control means 15 can be simplified, and a control having performance similar to that of the tilt correction control means 15 of the optical disc device 2010 of the second embodiment shown in FIG. 8 can be realized.

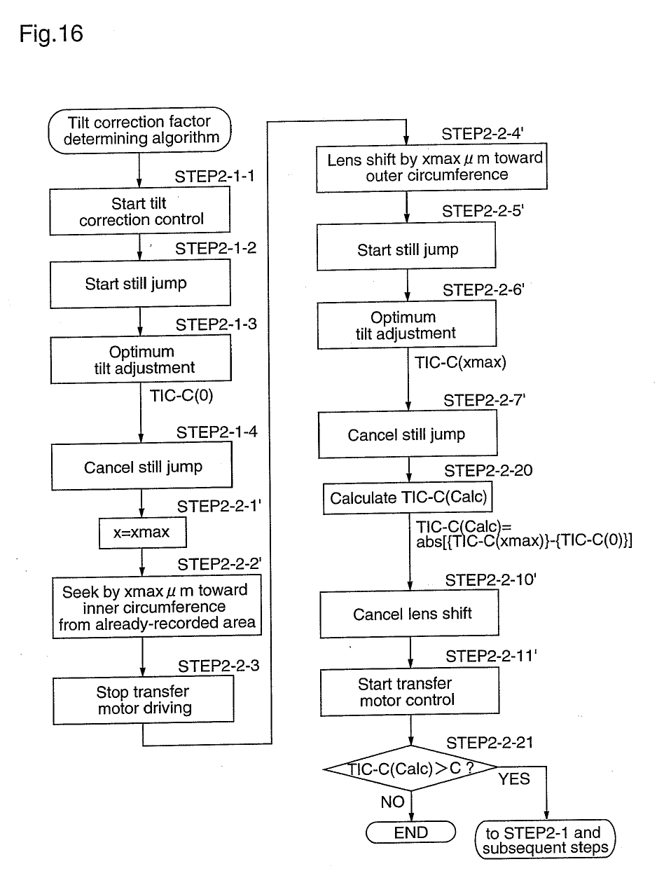

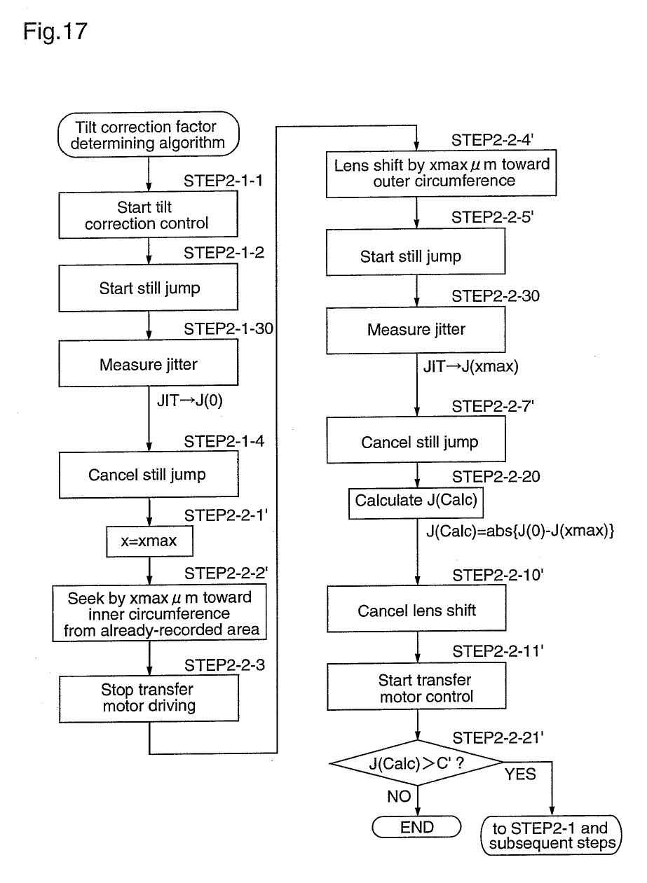

When the variation of the tilt with respect to the light axis deviation is small, the tilt correction control can be dispensed with, which will be described hereinafter with reference to FIGS. 16 and 17.

FIG. 16 is a flowchart illustrating a fourth method of determining the gain k of the tilt correction control means 15 in the optical disc device 2010 of the second embodiment. In FIG. 16, the same steps as those in the flowchart of FIG. 11 are given the same reference numerals.

First of all, since the beam spot has already been moved to the recorded area on the disc 1, the microcomputer 10B outputs a TICON/OFF signal to the tilt correction control means 15 so as to execute tilt correction control (STEP2-1-1). Next, still jump is started (STEP2-1-2). Subsequently, optimum tilt adjustment is performed in the state where no lens shift occurs, and a tilt correction amount TIC-C which minimizes the jitter is detected to be stored as TIC-C(0) (STEP2-1-3).

Subsequently, still jump is canceled (STEP2-1-4), and a value xmax with which the objective lens 2-5 is most shifted is set on the tilt correction control means 15 and on the microcomputer 10 (STEP2-2-1′).

Then, the beam spot is moved by xmax μm toward the inner circumference from the position where the optimum tilt adjustment has been performed in STEP2-1-2 (STEP2-2-2′). Then, the microcomputer 10B outputs a transfer control signal SL-C which makes the drive signal zero to the transfer motor drive means 12 so as to stop the transfer motor 3 (STEP2-2-3′).

Next, the microcomputer 10B outputs a lens shift drive signal LS-C which shifts the objective lens 2-5 by xmax μm toward the outer circumference, through the tracking drive means 6 to the tracking actuator 2-8 (STEP2-2-4′). Subsequently, still jump is restarted (STEP2-2-5′). Thereby, the beam spot is controlled to be positioned near the same track as the track for which the optimum tilt adjustment has been executed in STEP2-1-2.

Then, optimum tilt adjustment is performed in the state where the objective lens 2-5 is shifted by xmax μm toward the outer circumference, and a tilt correction amount TIC-C is detected to be stored as TIC-C(xmax) (STEP2-2-6′).

After the optimum tilt adjustment is ended, an absolute value of a difference between the tilt correction amount TIC-C(0) and the TIC-C(xmax) which are detected in STEP2-1-3 and STEP2-2-6′, respectively, is calculated using formula 1 (STEP2-2-20).

TIC-C(Calc)=[{TIC-C(xmax)}−{TIC-C(0)}] (1)

Subsequently, lens shift is again canceled (STEP2-2-10′), and the microcomputer 10B restarts control for the transfer motor 3 (STEP2-2-11′).

Next, the tilt correction control means 15 compares the TIC-C(Calc) calculated in STEP2-2-2 with a predetermined value C, and when the TIC-C(Calc) is smaller than the value C (No in STEP2-2-21), the control is turned off with the predetermined gain k of the tilt correction control means 15 being constantly zero. When the TIC-C(Calc) is not smaller than the value C (Yes in STEP2-2-21), the operation goes back to STEP2-1-1 in FIG. 11 to determine the gain k.

FIG. 17 is a flowchart illustrating a fifth method of determining the gain k by the tilt correction control means 15 in the optical disc device 2010 of the second embodiment.

As shown in the fifth flowchart of FIG. 17, the microcomputer 10B may measure J(0) and J(xmax) which are the outputs JIT of the jitter detection means 9 obtained when the lens shift amount is zero and when the lens shift amount is xmax in STEP2-1-30 and STEP2-2-30 instead of STEP2-1-3 and STEP2-2-6′ in the fourth flowchart of FIG. 16, respectively, and only when an absolute value J(Calc) of a difference between these outputs is larger than a predetermined value C′ (Yes in STEP2-2-21′), tilt correction control may be executed. Thus, by comparing a difference between the quality of the reproduction signal in the state where no light axis deviation occurs and the quality of the reproduction signal in the state where a light axis deviation occurs with the predetermined value, the same effect as described for the fourth flowchart shown in FIG. 16 can be obtained.

A part of the optical disc device 2010 shown in FIG. 7(a) can be configured by an integrated circuit 21 as described below.

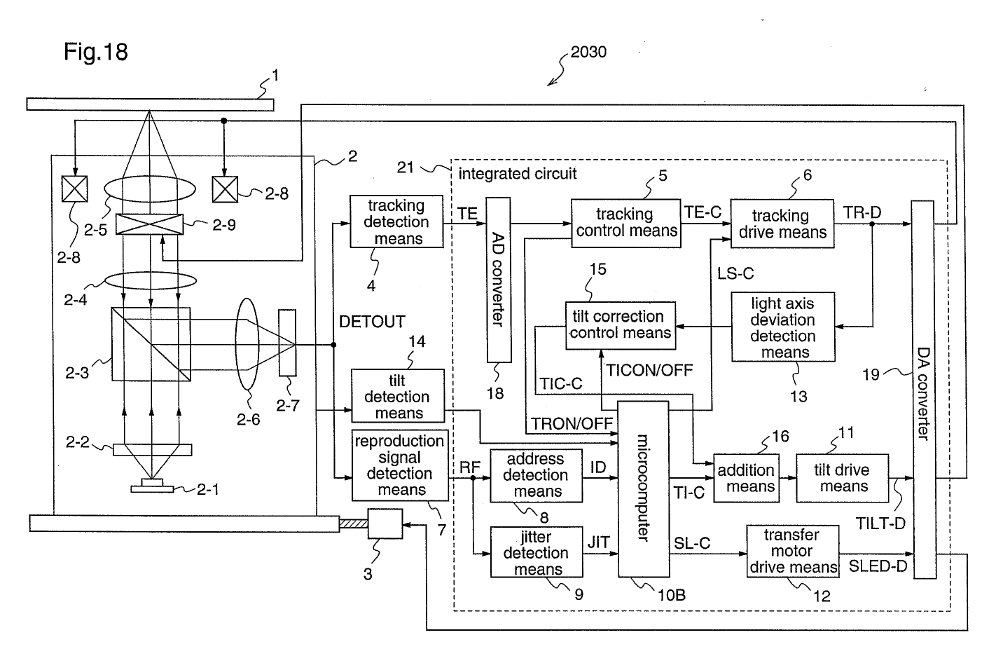

FIG. 18 is a block diagram illustrating an optical disc device 2030 including the integrated circuit 21 according to the second embodiment of the present invention. In the optical disc device 2030 of the second embodiment, the same constituents as those of the optical disc device 2010 are given the same reference numerals to omit the description thereof.

In the optical disc device 2030 of the second embodiment, a tracking control system comprising an AD converter 18 for converting an analog signal from the tracking detection means 4 into a digital signal, a tracking control means 5, and a tracking drive means 6 is configured by digital control, and a tilt control system comprising an address detection means 8, a jitter detection means 9, a microcomputer 10B, a light axis deviation detection means 13, a tilt correction control means 15, an addition means 16, a tilt drive means 11, and a transfer motor drive means 12 is configured by a digital control, and the outputs from the tracking drive means 6, the tilt drive means 11, and the transfer motor drive means 12 are converted into analog signals by a DA converter 19, and further, these functions are integrated to provide an integrated circuit 21.

The functions of the tracking control means 5, the light axis deviation detection means 13, the tilt correction control means 15, the addition means 16, and the microcomputer 10B may be configured by a tilt control program.

As described above, the optical disc device of the second embodiment is provided with the tilt detection means 13 which detects a warpage of the optical disc, the microcomputer 10B which outputs a signal for controlling a tilt of the objective lens on the basis of the output of the tilt detection means 13, the tilt correction control means 15 which determines a tilt correction amount for controlling the tilt of the objective lens on the basis of the output of the light axis deviation detection means, the addition means 16 which adds the output of the microcomputer 10B and the output of the tilt correction control means 15, and the tilt drive means 11 which controls the tilt of the objective lens on the basis of the output of the addition means 16, and if the reflected light applied onto the reproduction light detector is deteriorated by a tilt of the objective lens or a coma aberration which occurs due to a light axis deviation caused by a lens shift of the objective lens when recording data in the recording medium or when reproducing data from the recording medium, a tilt correction control for appropriately controlling the influence of the optical axis deviation by using a correction value according to the light axis deviation amount is carried out in addition to a tilt control for controlling the influence of disc warpage, thereby to control the tilt of the objective lens. Therefore, deterioration of the reproduction signal based on the reflected light from the recording medium can be precisely controlled, thereby realizing precise data recording or reproduction.

Further, only when the influence of deterioration of the reproduction signal due to a tilt of the objective lens or a coma aberration of the pickup which occurs due to a light axis deviation caused by a lens shift of the objective lens when recording data on the recording medium or reproducing data from the recording medium, a tilt correction control for appropriately controlling the influence of the light axis deviation is carried out in addition to a tilt control for controlling the influence of disc warpage, whereby deterioration of the reproduction signal based on the reflected light from the recording medium can be accurately suppressed according to need. Further, since no tilt correction control is executed when the influence of deterioration of the reproduction signal due to the light axis deviation is small, even when the output of the light axis deviation detection means becomes abnormal due to a light axis deviation of the objective lens, an excessive input signal is not applied to the tilt actuator, and thereby such as malfunction of the device can be avoided.

### EMBODIMENT 3

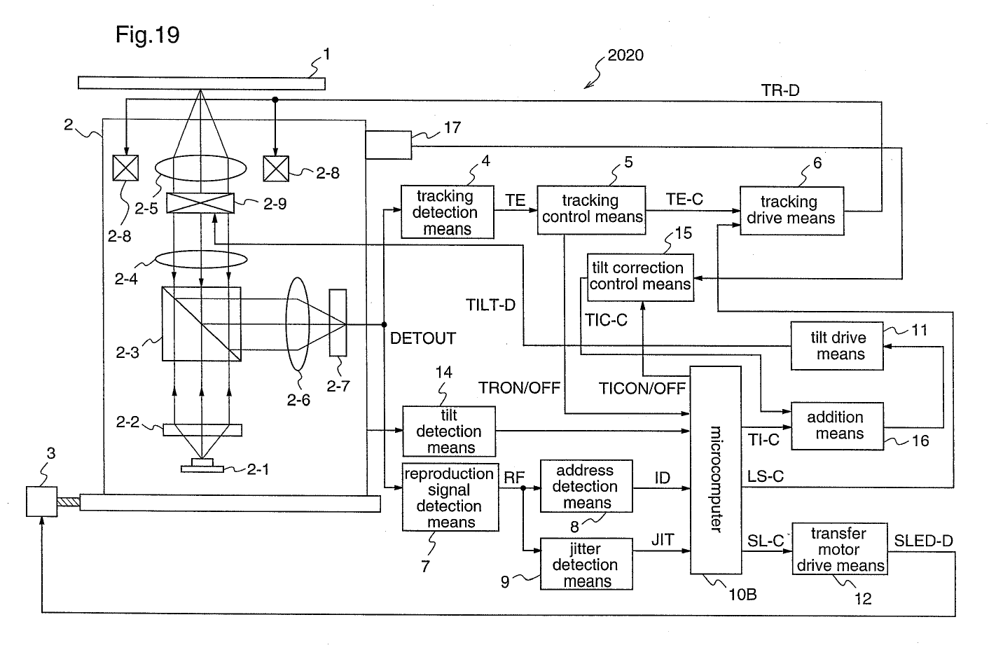

FIG. 19 is a diagram illustrating an optical disc device 2020 according to a third embodiment of the present invention.

In the optical disc device 2020 of the third embodiment, the same constituents as those of the optical disc device 2010 of the second embodiment are given the same reference numerals to omit the description thereof.

In the optical disc device 2010 of the second embodiment, as shown in FIG. 7(a), the light axis deviation detection means 13 estimates the light axis deviation amount of the beam spot that is focused by the objective lens 2-5, and outputs the estimated value to the tilt correction control means 15. In the optical disc device 2020 of this third embodiment, however, a light axis sensor 17 detects a light axis deviation amount to output the same to the tilt correction control means 15 as shown in FIG. 19.

Also in this configuration, the same performance and effect as those of the optical disc device 2010 of the second embodiment shown in FIG. 7(a) can be obtained.

As described above, the optical disc device 2020 of the third embodiment includes the tilt correction control means 15 which determines and outputs a tilt correction amount for controlling a tilt of the objective lens on the basis of the output of the light axis deviation sensor 17 which detects a light axis deviation amount of the emitted light from the objective lens which focuses a light beam on the optical disc, the microcomputer 10B which outputs a signal for controlling the tilt of the objective lens on the basis of the output of the tilt detection means 14, the addition means 16 which adds the output of the microcomputer 10B and the output of the tilt correction control means 15, and the tilt drive means 11 which controls the tilt of the objective lens on the basis of the output of the addition means 16, and if the reflected light applied onto the reproduction light detector is deteriorated by a tilt of the objective lens or a coma aberration which occurs due to a light axis deviation caused by a lens shift of the objective lens when recording data in the recording medium or reproducing data from the recording medium, the tilt of the objective lens is controlled by performing a tilt correction control for accurately detecting the light axis deviation and appropriately controlling the influence of the light axis deviation by a correction value according to the light axis deviation amount, in addition to a tilt control for controlling the influence of disc warpage. Therefore, deterioration of the reproduction signal based on the reflected light from the recording medium can be accurately suppressed, and thereby accurate data recording or reproduction can be carried out.

### EMBODIMENT 4

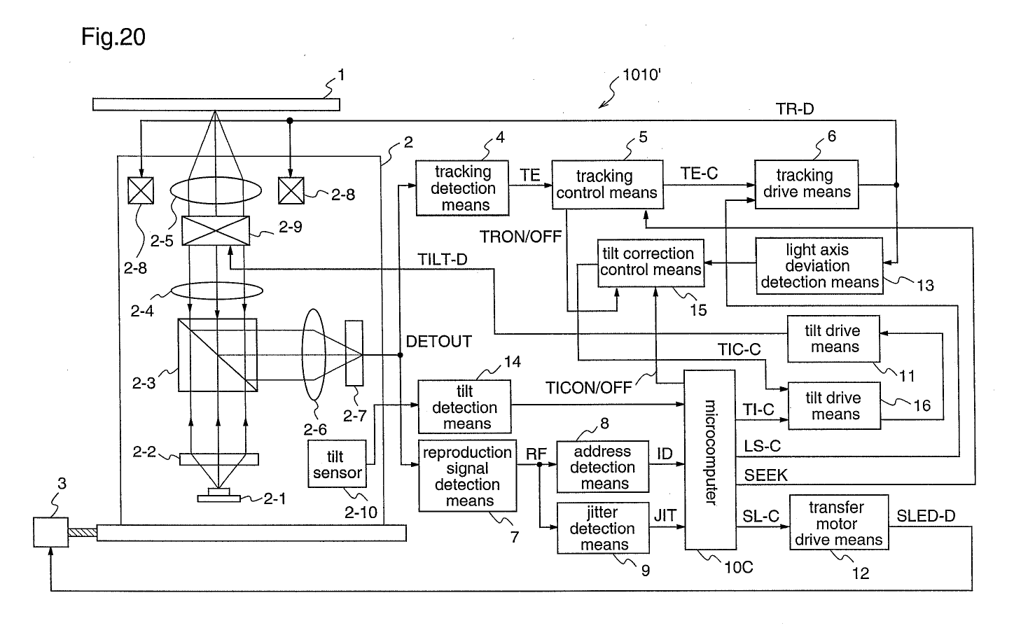

FIG. 20 is a block diagram illustrating an optical disc device 2010′ according to a fourth embodiment of the present invention.

In the optical disc device 2010′ of this fourth embodiment, the same constituents as those of the optical disc device 2010 of the second embodiment are given the same reference numerals to omit the description thereof.

While in the optical disc device 2010 of the second embodiment the microcomputer 10B is configured to output the drive current TILT-D, the lens shift drive signal LS-C, and the transfer motor drive signal SLED-D as shown in FIG. 7(a), a microcomputer 100 of this fourth embodiment is configured to further output a seek signal SEEK to the tracking control means 5. The tracking control means 5 is configured to turn on or off tracking control on the basis of the seek signal SEEK outputted from the microcomputer 100, and output a tracking control signal TRON/OFF to the tilt correction control means 15. The seek signal SEEK is in its ON state when the beam spot focused on the disc 1 is moved to an arbitrary track, and the microcomputer 100 outputs a transfer control signal SL-C to the transfer motor drive means 12 to move the pickup 2 to an arbitrary position in the radial direction of the disc 1.

Next, the function of the tilt correction control means 15 will be described. As already described in the second embodiment with reference to FIG. 8, a tilt correction amount TIC-C is generated by multiplying the output of the light axis deviation detection means 13 by the gain k. In this fourth embodiment, outputting of the tilt correction amount TIC-C is switched on or off according to the TRON/OFF signal outputted from the tracking control means 5.

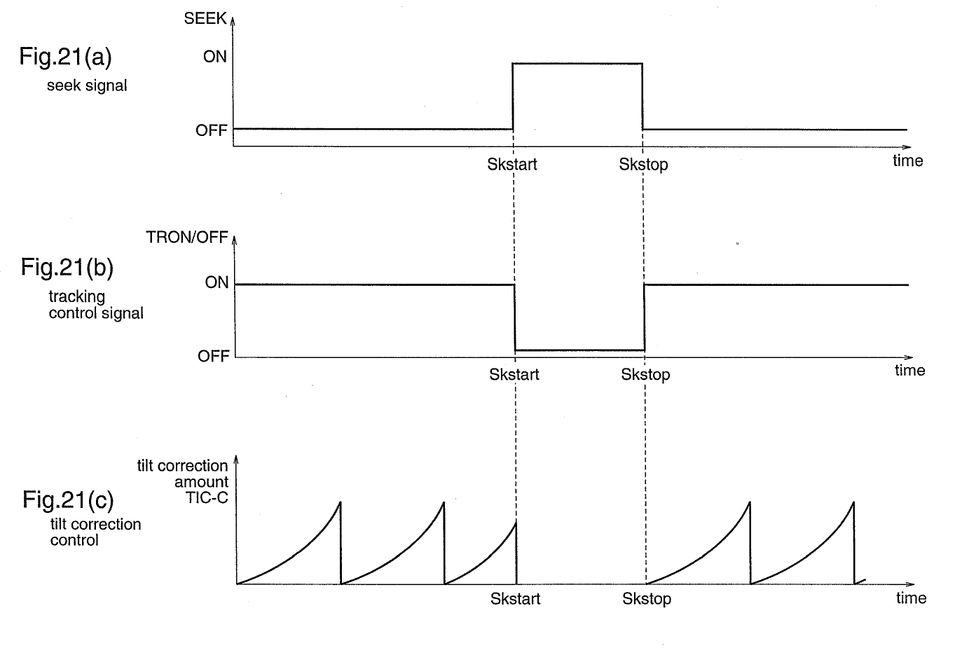

The effect of the above-described construction will be described with reference to FIG. 21.

FIG. 21 is a diagram illustrating the seek signal SEEK (a), the tracking control signal TRON/OFF (b), and the tilt correction amount TIC-C (c) which are outputted while the optical disc device 2010′ of the fourth embodiment shown in FIG. 20 reproduces data recorded on the disc 1, temporarily stops the reproduction to move the beam spot to an arbitrary track on the disc 1, and again starts the data reproduction, wherein the abscissa shows time.

In FIG. 21, the optical disc device 2010 reproduces data from an arbitrary track on the disc 1 until time SkStart. So, as shown in FIG. 21(a), the microcomputer 10C outputs an OFF signal as a seek signal SEEK to the tracking control means 5. The tracking control means 5 closes the tracking control loop in order to determine the position of the beam spot onto a desired track. Accordingly, as shown in FIG. 21(b), the tracking control means 5 outputs an ON signal as a tracking control signal TRON/OFF to the tilt correction control means 15. As described with reference to FIG. 13, the tilt correction control means 15 outputs a tilt correction amount ITC-C according to a lens shift amount of the objective lens 2-5 as shown in FIG. 21(c).

Subsequently, at time SkStart, the microcomputer 10C temporally stops the data reproduction on the disc 1, and starts a seek operation to move the beam spot focused by the objective lens 2-5. Then, the microcomputer 10C outputs an ON signal as a seek signal SEEK to the tracking control means 5. As the result, the tracking control means 5 opens the tracking control loop, and outputs an OFF signal as the tracking control signal TRON/OFF to the tilt correction control means 15. The tilt correction control means 15 stops outputting of the tilt correction amount TIC-C because the tracking control signal TRON/OFF is off. Then, the microcomputer 10C outputs a transfer motor drive signal SLD-D to move the pickup 2 to an arbitrary position in the radial direction of the disc 1.

At time SkStop, the pickup 2 is moved to the arbitrary position in the radial direction of the disc 1, and the tracking control loop is again closed. Accordingly, the microcomputer 10C outputs an OFF signal as a seek signal SEEK to the tracking control means 5. The tracking control means 5 again closes the tracking control loop, and outputs an ON signal as a tracking control signal TRON/OFF to the tilt correction control means 15. Then, the tilt correction control means 15 restarts outputting of the tilt correction amount TIC-C to start data reproduction from the disc 1.

While in FIG. 21 outputting of the tilt correction amount TIC-C is restarted at time SkStop, it may be restarted after waiting a predetermined period until the tracking control is stabilized (not shown).

As described above, in the optical disc device 2010′ of this third embodiment, the tilt correction amount TIC-C is made zero when the tracking control loop for positioning the light beam onto an arbitrary track on the optical disc is open. Therefore, even when abnormality occurs in the output of the tilt detection means 14 due to vibration of the objective lens 2-5 which is caused by transfer of the pickup 2 or when the output TR-D of the tracking drive means 6 becomes an abnormal signal for some reasons during the seek period (from time SkStart to time SkStop), since the tilt correction control means 15 stops outputting of the tilt correction amount TIC-C, the drive current TILT-D which is outputted from the tilt drive means 11 to the tilt actuator 2-9 is in the constant state, and thereby stable seek control can be realized.

### APPLICABILITY IN INDUSTRY

A tilt control method, an integrated circuit, and an optical disc device of the present invention can perform tilt correction not only for a disc warpage but also for a tilt of an objective lens and a coma aberration of a pickup which are caused by lens shift, and are useful in providing a tilt control method, an integrated circuit, and an optical disc device which appropriately suppress deterioration of a reproduction signal based on a reflected light from the optical disc when recording data on a recording medium or reproducing data from the recording medium.

1. A tilt control method comprising:
a first step of detecting a light axis deviation amount of an emission light from an objective lens which focuses a light beam on an optical disc;
a second step of detecting a disc warpage amount of the optical disc; and
a third step of controlling a tilt of the objective lens on the basis of the light axis deviation amount detected in the first step and the disc warpage amount detected in the second step.

2. A tilt control method comprising:
a first step of detecting a light axis deviation amount of an emission light from an objective lens which focuses a light beam on an optical disc;
a second step of determining a tilt correction amount on the basis of the light axis deviation amount detected in the first step;
a third step of adding the tilt correction amount determined in the second step and an output which corrects a warpage of the optical disc; and
a fourth step of controlling a tilt of the objective lens according to the result of the addition in the third step.

3. A tilt control method as defined in claim 2 wherein
said second step includes
determining a tilt correction amount on the basis of the light axis deviation amount detected in the first step, with the tilt of the objective lens being previously controlled with respect to the warpage of the optical disc.

4. A tilt control method as defined in claim 2 wherein
said second step includes
performing an operation of generating a light axis deviation of a predetermined amount and detecting an output which controls the tilt of the objective lens to optimize a reproduction signal, with varying the predetermined amount on at least two points on the optical disc,
calculating a ratio between the predetermined amount and the output which controls the tilt of the objective lens, and
multiplying the optical axis deviation amount detected in the first step by the ratio, thereby to determine a tilt correction amount.

5. A tilt control method as defined in claim 3 wherein
said second step includes, with the tilt of the objective lens being previously controlled with respect to the warpage of the optical disc,
performing an operation of generating a light axis deviation of a predetermined amount and detecting an output which controls the tilt of the objective lens to optimize a reproduction signal, with varying the predetermined amount on at least two points on the optical disc,
calculating a ratio between the predetermined amount and the output which controls the tilt of the objective lens, and
multiplying the optical axis deviation amount detected in the first step by the ratio, thereby to determine a tilt correction amount.

6. A tilt control method as defined in claim 2 wherein
said second step includes
performing an operation of generating a light axis deviation of a predetermined amount and detecting an output which controls the tilt of the objective lens to optimize a reproduction signal, with varying the predetermined amount on at least two points on the optical disc,
calculating ratios between the predetermined amounts and the output which controls the tilt of the objective lens, and making a table including the ratios and the corresponding light axis deviation amounts,
determining the ratio from the table according to the light axis deviation amount detected in the first step, and
multiplying the optical axis deviation amount detected in the first step by the ratio, thereby to determine a tilt correction amount.

7. A tilt control method as defined in claim 3 wherein
said second step includes, with the tilt of the objective lens being previously controlled with respect to the warpage of the optical disc,
performing an operation of generating a light axis deviation of a predetermined amount and detecting an output which controls the tilt of the objective lens to optimize a reproduction signal, with varying the predetermined amount on at least two points on the optical disc,
calculating ratios between the predetermined amounts and the output which controls the tilt of the objective lens, and making a table including the ratios and the corresponding light axis deviation amounts,
determining the ratio from the table according to the light axis deviation amount detected in the first step, and
multiplying the optical axis deviation amount detected in the first step by the ratio, thereby to determine a tilt correction amount.

8. A tilt control method as defined in claim 2, wherein
said second step includes
detecting an output which controls the tilt of the objective lens to optimize the reproduction signal in a state where no light axis deviation is generated, and an output which controls the tilt of the objective lens to optimize the reproduction signal in a state where a light axis deviation is generated,
calculating a ratio of the output which controls the tilt of the objective lens to the optical axis deviation amount, and
making the tilt correction amount zero when the ratio is smaller than a first predetermined value.

9. A tilt control method as defined in claim 2, wherein
said second step includes
making the tilt correction amount zero when a difference between the quality of the reproduction signal in a state where no light axis deviation is generated and the quality of the reproduction signal in a state where a light axis deviation is generated is smaller than a first predetermined value.

10. A tilt control method as defined in claim 2, wherein
said second step includes
making the tilt correction amount zero when a tracking control loop which controls positioning of the light beam onto an arbitrary track on the optical disc is open.

11. An integrated circuit comprising:
a light axis deviation detection means which detects a light axis deviation amount of an emission light from an objective lens which focuses a light beam on an optical disc;
a tilt detection means which detects a warpage of an optical disc;
a tilt control means which outputs a signal for controlling a tilt of the objective lens on the basis of the output of the tilt detection means;
a tilt correction control means which determines and outputs a tilt correction amount for controlling the tilt of the objective lens on the basis of the output of the light axis deviation detection means;
an addition means which adds the output of the tilt control means and the output of the tilt correction control means; and
a tilt drive means which controls the tilt of the objective lens according to the output of the addition means.

12. An integrated circuit as defined in claim 11 wherein
said tilt correction control means
performs an operation of generating a light axis deviation of a predetermined amount and detecting an output which controls the tilt of the objective lens to optimize a reproduction signal, with varying the predetermined amount on at least two points on the optical disc,
calculates a ratio between the predetermined amount and the output which controls the tilt of the objective lens, and
outputs, as a tilt correction amount, a value obtained by multiplying the output of the light axis deviation detection means by the ratio.

13. An integrated circuit as defined in claim 11 wherein
said tilt correction control means
performs an operation of generating a light axis deviation of a predetermined amount and detecting an output which controls the tilt of the objective lens to optimize a reproduction signal, with varying the predetermined amount on at least two points on the optical disc,
calculates ratios between the predetermined amounts and the output which controls the tilt of the objective lens, and makes a table including the ratios and the corresponding light axis deviation amounts,
determines the ratio from the table according to the light axis deviation amount detected by the light axis deviation detection means, and
outputs, as a tilt correction amount, a value obtained by multiplying the output of the light axis deviation detection means by the ratio.

14. An integrated circuit as defined in claim 11 wherein
said tilt correction control means
detects an output which controls the tilt of the objective lens to optimize the reproduction signal in a state where no light axis deviation is generated, and an output which controls the tilt of the objective lens to optimize the reproduction signal in a state where a light axis deviation is generated,
calculates a ratio of the output which controls the tilt of the objective lens to the light axis deviation amount, and
makes the tilt correction amount zero when the ratio is smaller than a first predetermined value.

15. An integrated circuit as defined in claim 11 wherein
said tilt correction control means makes the tilt correction amount zero when a difference between the quality of the reproduction signal in a state where no light axis deviation is generated and the quality of the reproduction signal in a state where a light axis deviation is generated is smaller than a first predetermined value.

16. An integrated circuit as defined in claim 11 wherein
said tilt correction control means makes the tilt correction amount zero when a tracking control loop which controls positioning of the light beam onto an arbitrary track on the optical disc is open.

17. An optical disc device comprising:
an objective lens which focuses a light beam on an optical disc;
a tilt actuator which varies a tilt of the objective lens;
a light axis deviation detection means which detects a light axis deviation of an emission light from the objective lens;
a tilt detection means which detects a warpage of the optical disc;
an objective lens tilt control means which controls the tilt of the objective lens on the basis of the output of the light axis deviation detection means and the output of the tilt detection means; and
a tilt drive means which drives the tilt actuator on the basis of the output of the objective lens tilt control means.

18. An optical disc device comprising:
an objective lens which focuses a light beam on an optical disc;
a tilt actuator which varies a tilt of the objective lens;
a light axis deviation detection means which detects a light axis deviation of an emission light from the objective lens;
a tilt detection means which detects a warpage of the optical disc;
a tilt correction control means which determines and outputs a tilt correction amount on the basis of the output of the light axis deviation detection means;
a tilt control means which outputs a signal for controlling the tilt of the objective lens on the basis of the output of the tilt detection means;
an addition means for adding the output of the tilt control means and the output of the tilt correction control means; and
a tilt drive means which drives the tilt actuator according to the output of the addition means.

19. An optical disc device comprising:
an objective lens which focuses a light beam on an optical disc;
a tilt actuator which varies a tilt of the objective lens;
a light axis deviation sensor which detects a light axis deviation of an emission light from the objective lens;
a tilt detection means which detects a warpage of the optical disc;
a tilt correction control means which determines and outputs a tilt correction amount on the basis of the output of the light axis deviation sensor;
a tilt control means which outputs a signal for controlling the tilt of the objective lens on the basis of the output of the tilt detection means;
an addition means for adding the output of the tilt control means and the output of the tilt correction control means; and
a tilt drive means which drives the tilt actuator according to the output of the addition means.
